(19) United States
(12) Patent Application Publication
(10) Pub. No.: US 2024/0062601 A1
(43) Pub. Date: Feb. 22, 2024

(54) Adaptable Secured Asset Transfer System for Use with Multiple Electronic Locker Form Factors

(71) Applicant: AirLocker, Inc., Berkeley, CA (US)

(72) Inventors: Thomas Corder, Danville, CA (US); James Mullin, Livermore, CA (US); Mark Potts, Oakland, CA (US); Juan Acuna, San Francisco, CA (US); Melvin Kneip, Claremont, CA (US)

(73) Assignee: AirLocker, Inc., Berkeley, CA (US)

(21) Appl. No.: 18/206,039

(22) Filed: Jun. 5, 2023

Related U.S. Application Data
(60) Provisional application No. 63/348,485, filed on Jun. 3, 2022.

(51) Int. Cl. G07C 9/00

(52) U.S. Cl. CPC G07C 9/00896

(57) ABSTRACT

An adaptable secured asset transfer system is provided where the system includes an electronic locker system, comprising at least one physical locker form factor, and connected via a network to a server system configured to manage a plurality of physical locker form factors. Form factors may include: personal electronic lockers affixed to a wall or desktop; mobile lockers mounted on wheels; a bank/set of contiguous lockers (stationary or movable). The system is configured to monitor access to a plurality of physical assets placed within the electronic locker system. The secured asset transfer system is adaptable to provide secured asset transfer of physical assets as needs of an enterprise fluctuate over time. The system includes software comprising an authentication protocol that restricts access to physical assets located within the electronic locker system, and a software-enabled method for monitoring usage over time, managing throughput, allocating various form factors, and facilitating system reconfigurations.

### CLAIM OF PRIORITY

This application claims priority to U.S. Provisional Patent Application Ser. No. 63/348,485 filed on Jun. 3, 2022, titled “Adaptable Secured Asset Transfer System for Use with Multiple Electronic Locker Form Factors” of which is incorporated by reference in its entirety.

### BACKGROUND OF THE INVENTION

### 1. Field of the Invention

This disclosure generally relates to electronic locker systems.

### 2. Related Art

Conventional electronic locker systems are primarily used for package delivery in residential multi-family housing and on university campuses. The use case for these systems is essentially the same: A delivery courier arrives at a property, enters the recipient's name on a kiosk touchscreen, locates the recipient, selects the locker size and deposits the package into a locker compartment. The locker system then sends an email to the recipient notifying them that they have a package waiting at the lockers. These lockers are typically operated from the cloud and the apartment resident is required to log onto the vendor's website and register their location. They are often required to establish a credit card account to pay an annual fee or to pay if they “abuse” the system. For example, if a consumer does not pick up their package within a few days, this is considered abuse and the resident will be charged a few dollars for each day they do not pick up their package.

Brick and mortar commercial retailers may also use conventional electronic locker systems to manage fulfilment of orders placed on-line by deploying electronic lockers in their stores or within the immediate vicinity of the store. This has been called Buy-On-Line-Pick-Up-In-Store (“BOPIS”). The problem with BOPIS is that each retailer is forced to invest in their own electronic locker solution, which presents a new cost center and service challenges, so that only large “box retailers” have the staff and financial resources to implement electronic BOPIS locker solutions. Although smaller retailers may be interested in an electronic locker system for pick-up of orders placed online, they do not have the resources to purchase and operate their own dedicated system. In addition, if many small retailers would want to install an electronic locker system outdoors or in malls, they may be subject to ‘limitations and regulations” imposed by the local mall or city managers limiting their numbers. Lack of cost-effective BOPIS locker solutions for many brick and mortar commercial retailers creates inconvenience and other concerns for on-line shoppers who would rather not ship purchases to their place of residence.

As e-commerce grows, theft of packages left on porch steps of single-family homes grows with it. One alternative is for a consumer to have an on-line order shipped to their place of work instead. But that alternative may not always be an option for many on-line consumers, even for large corporate employees, particularly since a corporation may have policies that discourage its employees from shipping personal on-line purchases to the workplace in an attempt to mitigate increased package load for the employer's mail handlers arising from personal mail deliveries.

Corporations furthermore have their own concerns relating to package delivery handling. Different corporations have addressed the secured package problem differently. Some larger corporations have added internal “package concierge” personnel to manage package delivery, while other corporations subcontract their mailroom and package handling operations to third party firms. Most corporations require an employee package recipient to come to the package room location to retrieve their package. If the package room is staffed, the package concierge will locate the package for the employee. If it is not, the employee will have to sort through the packages to find theirs. Neither solution is ideal: in one case the package concierge will only be available during normal office hours, and in the second case, requiring the employee to sort through packages to find theirs may substantially contribute to disorder in the package storage area.

To address the need for high-volume throughput of secured package delivery, some corporations and workspace providers are turning to software applications to help manage an every-increasing number of packages being delivered. Existing software applications provide and enable technology to (a) record when a package arrives by electronically scanning the label, (b) notify the recipient of the delivery with an email or text message, and (c) record the time the package is picked up. This information is helpful to log a recipient's receipt of a package, but these software applications do not provide additional automation that actually improves the package handling. For example, if the package is placed in a location where it cannot be quickly located at the time its intended recipient arrives to retrieve it, regardless of whether the package concierge or the recipient is the one left to actually retrieve the package, these software applications incorporate no automated features to help an individual find the delivered package at a precise location in the mailroom.

Alternatively, some corporations and shared workspace facilities may consider deploying a delivery locker system to help mitigate the problem of packages gone missing, and to provide secure package pick up after office hours and on weekends. Existing delivery locker systems, however, may not be suitable in many enterprise locations because of cost and complexity of installation, including space limitations and the challenges of meeting high-volume throughput needs. For example, where there is a high volume of packages, the lockers can quickly become fully occupied with packages if recipients do not pick up their packages promptly, and the benefit of delivery lockers becomes nil because no lockers are available.

Conventional electronic locker systems each target a discrete use case, offering a particular solution for a given application, such as package delivery; none currently offers a single, comprehensive electronic locker management system configured to operate with multiple use cases and with different hardware form factors. Furthermore, existing electronic locker systems do not provide locker solutions that can be easily expanded or relocated, and they do not provide solutions that integrate Internet connectivity, both wired and wireless connectivity (“Internet-of-Things” or “IoT” technology), in conjunction with data analytics capabilities to process usage data and provide usage information, such as actual content status, location and tamper condition, that can be used to adapt the installed system for evolving needs; for example, none of the existing electronic locker systems offer an electronic locker management system integrated with data analytics capabilities that can facilitate optimization of an electronic locker system installation, so that it can readily adapt or reconfigure, or be adapted and/or reconfigured to meet the evolving needs of its users. In addition, existing electronic locker systems are unable to meet evolving enterprise use cases that go beyond secured package delivery-such as secured, contactless transfers of physical assets between employees, or secured asset transfers and/or secured personal electronic locker spaces (time-shared or unshared) for personnel who may be working on-site, off-site, or in a hybrid mode (partially on-site, partially off-site).

The above limitations, among others, render conventional electronic locker systems effectively unable to support a long life-cycle when all of the use-cases, form factors and future corporate plans for any given enterprise are considered. Moreover, current limitations, complexities and costs associated with conventional electronic locker systems present significant challenges to meet the changing needs of an enterprise for whom a remote or hybrid workforce is becoming more and more frequent. What is needed is an adaptable, scalable, reconfigurable, secure asset transfer system for use with multiple electronic locker form factors and a management system.

This invention is an adaptable secured asset transfer system is provided that includes an electronic locker system, comprising at least one physical locker form factor, and connected via a network to a server system configured to manage a plurality of physical locker form factors. Form factors may include: personal electronic lockers affixed to a wall or desktop; mobile lockers mounted on wheels; a bank/set of contiguous lockers (stationary or movable). The system is configured to monitor access to a plurality of physical assets placed within the electronic locker system. The secured asset transfer system is adaptable to provide secured asset transfer of physical assets as needs of an enterprise fluctuate over time. The system includes software comprising an authentication protocol that restricts access to physical assets located within the electronic locker system, and a software-enabled method for monitoring usage over time, managing throughput, allocating various form factors, and facilitating system reconfigurations.

Other systems, methods, features, and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis being placed instead upon illustrating the principles of the invention. In the figures, like reference numerals designate corresponding parts throughout the different views.

FIG. 1 is a block diagram illustrating an example hardware system configuration of the secured asset transfer system.

FIG. 2 is a top view of a mobile cart locker system.

FIG. 3 is a side view of a mobile cart locker system.

FIG. 4 is a back view of a mobile cart locker system.

FIG. 5 is a side view of a mobile cart locker system.

FIG. 6 is a perspective view of a virtual locker system.

FIG. 7 is a is a perspective view of a virtual locker form factor illustrating a plurality of IoT sensors configured for use.

FIG. 8 is a side view of a virtual locker system.

FIG. 9 is a block diagram of the server application/system administration application operating in communication with the locker management application.

FIG. 10 is a block diagram of an electronic locker system software architecture.

FIG. 11 is a block diagram of a locker load module of the system software architecture.

FIG. 12 is a flow chart illustrating electronic locker system software.

FIG. 13 is a flow chart illustrating process steps of the system administration application.

FIG. 14 is a flow chart illustrating process steps of the system administration application.

FIG. 15 is a front view of a personal electronic locker system.

FIG. 16 is a side view of a personal electronic locker system.

FIG. 17 is a top view of a personal electronic locker system.

FIG. 18 is a perspective view of a pedestal locker system.

FIG. 19 is a perspective view of a pedestal locker system.

FIG. 20 is a perspective view of a pedestal locker system.

FIG. 21 is graphical user interface for a pedestal locker system.

FIG. 22 is perspective view of a pedestal locker system.

FIG. 23 is perspective view of a wall mounted safe box locker system.

FIG. 24 is perspective view of a wall mounted safe box locker system.

FIG. 25 is table mounted safe box locker system.

### DETAILED DESCRIPTION

Conventional electronic delivery locker systems are primarily designed for the residential apartment or consumer market. These systems cannot provide adequate or optimal solutions for corporate and government entities, who require a more robust secured asset transfer solution beyond the single-use case that is typical of residential package delivery and characteristic of the on-line consumer market. For example, in the use case to store an item, the function is “me to me” where one stores an item and later picks it up; in the use case for delivery, the function is to relay an item from me (a courier) to you (a recipient); and in the use case for inventory, the function is to stage an item from me (a supplier) to someone (the customer) sometime in the future. The functions can be described as store, relay and stage and each then supports one or more use cases. Each of the above are examples of the types of asset transfer process that can be implemented.

Various use cases can be implemented with this invention. For example, the locker systems may include (1) storage of a personal asset by a user for a limited or unlimited time period; (2) storage of an asset by a first user for a specific second user to retrieve; (3) storage of an asset by a first user that was requested by an asset requestor; (4) storage of an asset that is deposited for future retrieval by an asset requestor for some unspecified time in the future; storage of packages using multiple locker form factors; and (5) storage of multiple assets in advance of requests for the assets by multiple asset requesters at different time periods.

In addition to multiple use cases, an enterprise may have security concerns about allowing third party software to be installed on their corporate network, and/or may not be comfortable with having employees register for a company package delivery service running in the Cloud. Furthermore, some enterprises may require integration with an enterprise human resources system, use of a company ID credential, and/or extensive data collection. Enterprises may also require multiple use case applications and options for various hardware form factors. In addition, they may have a requirement for flexibility to expand and move portions of their locker systems as business needs change and the enterprise adapts. Additionally, the enterprise may receive packages that are larger than any available compartment in their locker system and therefore have a requirement for a remote electronic shelf that would be equipped with sensors to track where a package is placed for later retrieval.

In addition, the retailer's would also benefit from a multi-tenant, flexible yet secured locker system that can be readily adapted for simultaneous use by multiple retailers, incorporating an electronic locker allocation or load balancing algorithm that could fairly determine the number of locker compartments needed for each tenant based on past usage data, allocate lockers in an optimized way, and provide analytics on usage information to enable locker reconfigurations based upon changing usage and/or expected future retailer needs.

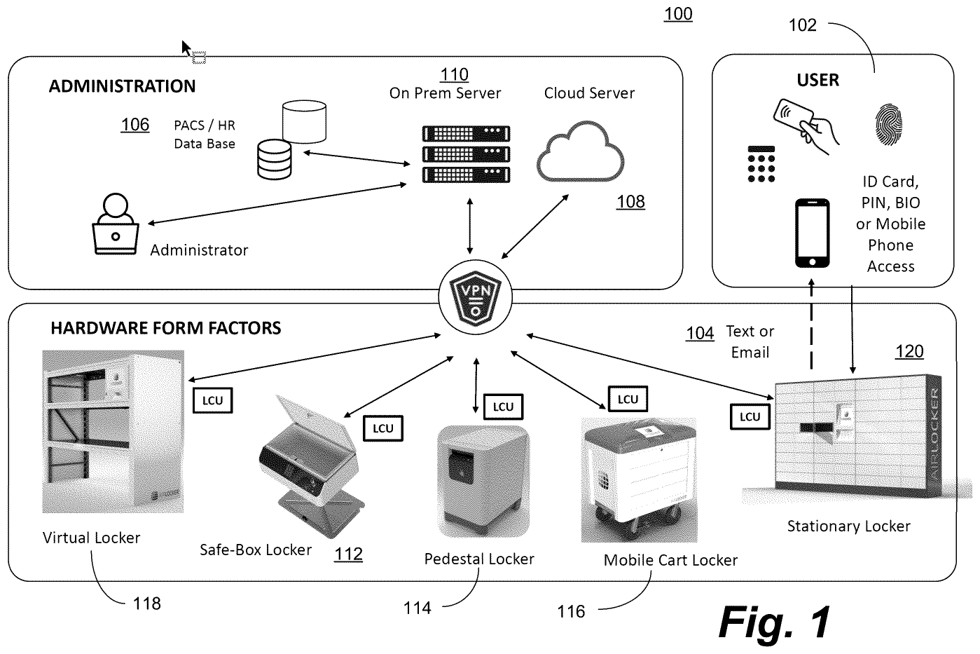

FIG. 1 illustrates a general system hardware configuration of the secured asset transfer system. As shown in FIG. 1, a secured asset transfer system includes one or more electronic locker systems having connectivity to a server configured to manage one or more secured locker form factors, which may include one or more personal electronic lockers affixed to a wall or desktop, one or more mobile electronic lockers mounted on wheels, a virtual electronic locker, and/or one or more moveable or stationary electronic locker banks. A server may be a single computer system, a collection of server computers, and/or a virtual server. The system is adaptable to provide secured asset transfer of physical assets as needs of an enterprise fluctuate throughout the day, week, month, or year. The system requires recipient authentication for access to a physical asset placed or stored within a secured locker form factor, and also permits monitoring use, managing throughput, and adapting the secured locker system to include different form factors, or different configurations of existing form factors as needs change. As described below, the system and method provides adaptable secured access and/or transfer of packages or other sensitive items to an intended recipient at a residence, enterprise, campus, office, retail establishment, or other location where third parties who are not the intended recipients may also have access.

As shown in FIG. 1, user authentication methods may include ID card access 102, QR code access, text or email authentication 104, and may include two-factor or more authentication methods. In the embodiment shown, a physical access control database (PACS DB) (or enterprise personnel database, EPDB) 106 is controlled and maintained by an enterprise administering, supervising and/or monitoring the secured asset transfer system, and is external to, but in communication with, a cloud server 108 or on premises server 110. In the embodiment shown, an additional database may be configured to store and maintain physical locker profiles. For example, a locker ID, form factor, size, use case), among other information pertaining to the electronic locker systems (collectively referred to as “locker profile information”). Such additional information may include historical information associated with electronic locker, such as an access time-period (short periods to unlimited time periods), a physical locker compartment access by use case, and a physical locker compartment access by size, and a user request profile.

As illustrated in FIG. 1, secured communication links between various components in the system may be hardwired or wireless, including over one or more cellular networks.

The secured asset transfer system also includes a locker management application, configured to enable functionality to a plurality of locker form factors, and to use applicable data inputs and historical utilization records to reconfigure the locker availability profile for an upcoming time-period, as further described below. Data may be input by devices that are well known in the art such as keypads, keyboards, barcode scanners, and wireless data input devices.

This disclosure will now be described with reference to the Figures, which in general relate to a secured asset transfer system adaptable for use with multiple electronic locker form factors. FIG. 1 illustrates five types of secured locker form factors may be included in the secured asset transfer system. As shown in FIG. 1, the secured locker form factors may include: (1) an individual personal electronic locker system configured to be securely fixed to a desk, a wall, or immoveable workspace feature (“safe-box locker”) 112; (2) an individual personal electronic locker system configured to be stored below or next to a work surface (“pedestal” locker) 114; (3) a mobile electronic locker system mounted on wheels (“mobile cart”) 116; (4) a virtual-locker system including one or more shelves and utilizing electronic positioning sensors to associate a package with a specific shelf location and/or virtual-locker locker compartment (a location on a shelf) 118; and (5) a stationary electronic locker system, also having a plurality of secured locker compartments 120. Other options may exist. In some embodiments, for example, the secured asset transfer system includes a stationary electronic locker system with a set of electronic locker banks wired by traditional dedicated cables, such as wireless or wired Ethernet or fiber optic wiring. In another embodiment, the set of electronic locker banks are wired with an internal serial network.

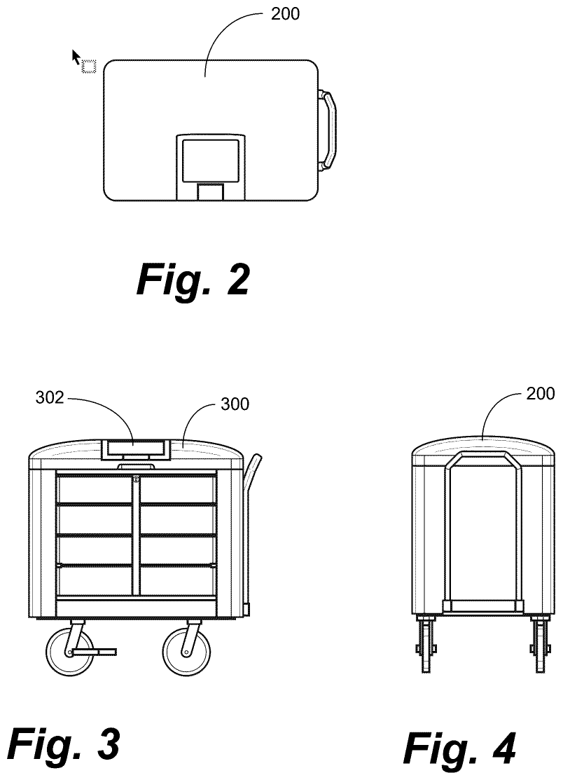

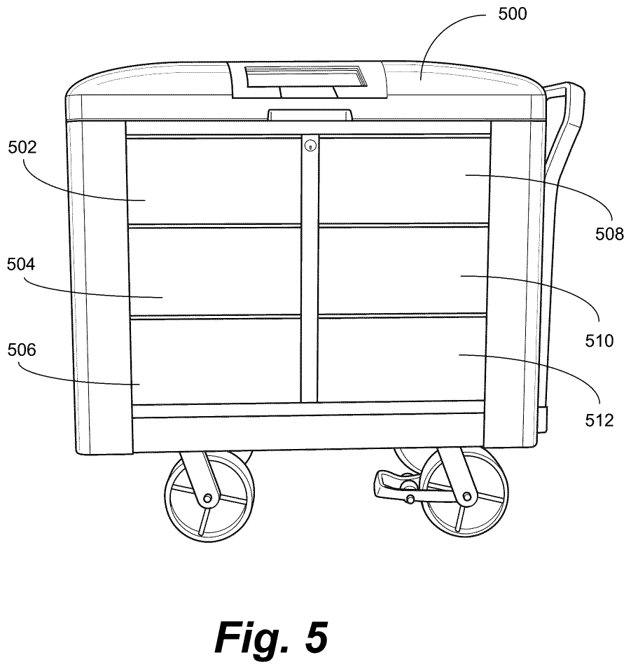

As one example electronic locker system that may be incorporated in the secured asset transfer system of FIG. 2-5, a secured locker form factor referred to generally as a mobile cart 200. This form factor includes, among other aspects, a locker touchscreen display 302 and a locker control unit for managing access to and operations of a plurality of locker components 502, 504, 506, 508, 510, and 512 of the mobile cart 500. In the example, the mobile cart electronic locker system 500 comprises multiple secured locker components in a single moveable chassis, and is mountable (or may be mounted) on wheels 514.

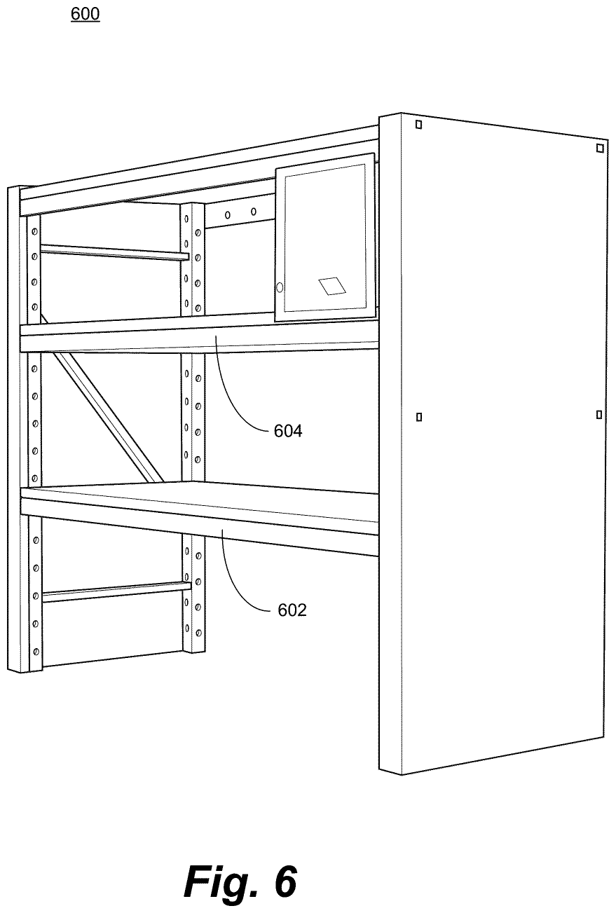

As another example of an electronic locker system that may be incorporated in the secured asset transfer system of FIG. 1, FIGS. 6, 7 and 8 illustrate another secured locker form factor referred to generally as a virtual-locker 600. In this embodiment, a virtual-locker is an electronic locker system designed to assist package room operators and recipients to deposit and retrieve packages with convenience. Electronic IoT sensors are positioned strategically on each shelf detect when a package is placed on a shelf and when one is removed. Provided the package room operator and the recipient log into the system using a locker control unit (such as an integrated kiosk), the system will identify who the package was left for and who retrieved it. A visual light, such as an LED light pipe, indicates approximately where a package was placed defining a virtual-locker locker compartment after the package was authenticated at the kiosk control station.

The secured asset transfer system and method provides a dedicated solution for improving the efficiency, security, data integrity and life-cycle value of items being transferred—or “relayed”-through various secure storage and staging solutions for differing use cases and form factors. For example, within an enterprise, incoming packages need to be delivered efficiently, employees need to store their personal belongings while at the office or may need to transfer an item to another team member who is working on a different schedule; a researcher may need to transfer a computer to a technician for service in a contactless mode; a research and development team may need to securely store sensitive items that are in development; a sales executive may need to stage a new product for a customer to pick up; or a firm may need to place critical items close to their customer where they can be accessed quickly.

The above business processes are typically referred to as use cases. In the physical world, however, there are other considerations. For example, the size and number of items being relayed, the facility plan, the organization and the specific use case may also require different secured locker form factors. This includes solutions for employees working at home.

The secured asset transfer system and method addresses the challenges relating to various use case and form factor needs, by providing, among others, a versatile, universal electronic locker system solution that is readily adaptable for use with multiple secured locker form factors, and readily scalable to an enterprise's changing use cases and needs for secured package delivery and secured asset transfer.

In addition to enterprises considering electronic package delivery lockers or ways to automate the handling of employee packages, many are beginning to discover other use cases for electronic lockers. For example, the Covid pandemic has driven interest in electronic lockers because they can facilitate “contactless” movement of packages, whether for package delivery or exchange of non-digital assets. In these scenarios, employees in one department or business unit may simply not want people from other departments or business units walking into their work area and need a solution for safe contactless transfer of assets.

There are other use cases where a group of employees may be working on sensitive projects involving non-digital hardware. Often the prototypes are required to be securely stored when they are not actively being worked on. Some of these office environments may not have the space for a bank of lockers or enough employees in a particular workspace to support a full locker bank. In this case, the locker optimization and management system enables the enterprise to allocate and manage secured personal electronic lockers, such as one or more of the locker form factors.

A secured personal electronic locker, as described in further detail below, is also useful to enterprises who are operating on a hybrid schedule that requires employees to reserve a “hot desk,” or time-shared workspace, when they do come to the office. Since these workers may not have the same workspace each day, a secured personal electronic locker that is mobile would be ideal for the hybrid worker. The system and method offers such mobility, connectivity and secured personal access not previously available.

The problem of secured storage with mobility is amplified with remote workers who may need to work with sensitive, non-digital devices as part of their job responsibilities. Research has shown that at least 50% and up to 80% of employees now prefer to work at home, so the problem is large and growing. Corporate security teams need solutions that protect the company's sensitive off-site devices when not being actively worked on or in service by their remote employees. A secured personal electronic locker may be deployed at home yet virtually connected to the corporate enterprise network via the Internet and a secured, virtual private network (VPN) communication link using Bluetooth, WiFi, Ethernet, cellular, or other communication protocols and/or systems for local connectivity. The secured asset transfer system controls and monitors physical access by an employee to sensitive company devices housed (when not in use) within the secured personal electronic locker deployed at the employee's remote work location, yet controlled and monitored as if the personal electronic locker were located on premises and connected to a corporate human resource or physical access system.

There are facilities, whether commercial or residential apartment buildings, where electronic lockers may not provide a fully comprehensive solution. For example, a location could receive packages that are too large for a locker compartment or there may be days when there is a large number of incoming packages, resulting in most if not all of the compartments in the locker bank to be occupied with packages. In addition, there could be locations where the local users are often away from the location and are not able to pick up their packages in a timely manner or there may be installations that simply do not have enough space to install the number of compartments needed.

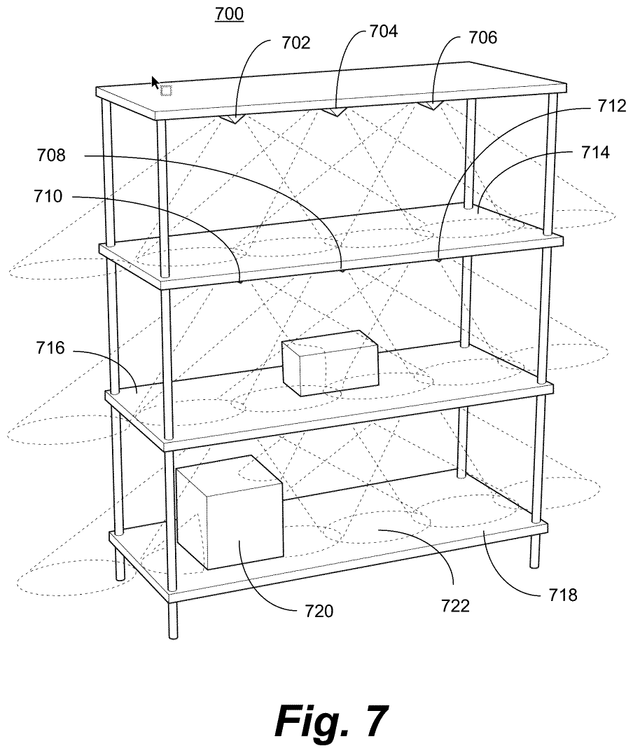

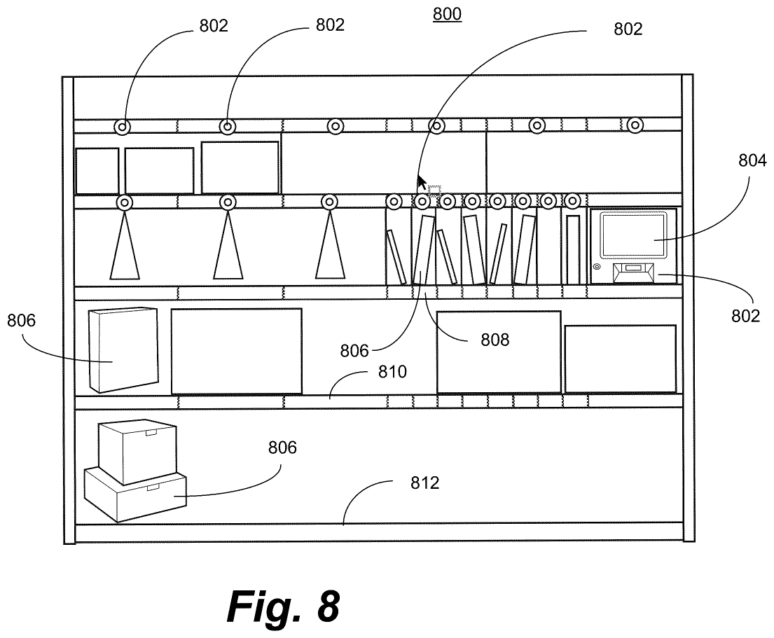

As one resolution to the aforementioned problems, and as shown in FIGS. 6, 7, and 8, a virtual-locker system is an embodiment of an electronic locker system designed to function in concert with other electronic locker systems of a secured asset transfer system, or as a stand-alone electronic virtual shelf. Packages are placed on the virtual shelf having virtual walls where the virtual shelf space and virtual wall is defined by the IoT sensors so that when a package is placed on the virtual shelf space within the virtual wall the IoT sensor identifies the package's present. FIG. 6 illustrates hardware components for one embodiment of a virtual-locker system form factor, and FIGS. 7 and 8 illustrate an example package sensor configurations of a virtual-locker system form factor.

In FIG. 6, a virtual-locker storage location comprises a doorless locker compartment which may or may not have side walls or back walls such as with a traditional locker system and one or more package sensors. In such a configuration, the virtual-locker locker compartment uses IoT sensor technology such as one or more time-of-flight sensors to configure one or more package sensors configured to identify a virtual-locker storage location where an inbound package has been placed in a virtual-locker bank 600, comprising one or more shelves 602 and 604. In such an embodiment, the package sensors are further configured to monitor the virtual-locker shelves and to determine, with a degree of accuracy, when a package is removed. Additional visual indicators may be used in close proximity with the package for the user to easily identify its location. Audio indicators can also be employed that warn a package recipient if they pick up the wrong package or the correct package. Also to help the package recipient, a display may be used to show the location within the room where the package is located. The virtual-locker may integrate a user authentication module, such as an RFID reader, a bar-code reader, a Bluetooth LTE transceiver or a keypad, with the one or more package sensors, all of which are integrated, with a single-board computer or solid state PC and a user I/O display to identify the virtual-locker storage location where a recipient's package is placed by a courier, and then to assist the recipient in finding the recipient's package.

The secured asset transfer system, and as illustrated generally in FIGS. 1, 6, 7 and 8, offers a person such as a courier an option to deposit a package at a virtual-locker on a virtual shelf with available space if the package is too large for an available locker compartment of a virtual shelf on a stationary locker bank, or if no locker compartments are available. In some embodiments, a virtual-locker option is presented to the user at an I/O display or touchscreen integral with a stationary locker system having no available locker compartment or inadequate locker compartments. The courier can then select the option to use a virtual-locker storage location and proceed to the virtual-locker.

The courier will enter a package identifier (e.g. scanning a bar-code ID) at a user authentication module, thereby associating the package with a recipient. The intended recipient may be selected from a recipient list displayed on a graphical user interface such as a touchscreen. The package may then be placed on a virtual-locker shelf with available and adequate shelf space. Sensing technology such as one or more time-of-flight sensors may be configured to identify where the package has been placed on any one of the virtual-locker shelves. An ID label affixed to the package, including a barcode label, is used to identify each package with a package ID; hardware and software of the secured asset transfer system is configured to associate that package ID to the virtual-locker storage location where the package was placed (e.g., a specific virtual-locker shelf and/or a specific virtual-locker locker compartment). The package, including its package ID and its virtual-locker storage location is provided to an electronic locker management application, thereby enabling one to track the package by its package ID, associate the package to its intended recipient, notify the intended recipient, and catalogue the virtual-locker storage location of the package on the series of open shelves, thereby enabling the recipient to quickly and conveniently retrieve the package at the virtual-locker system.

Secured access to the virtual-locker system is provided by establishing secured access to a secured access area housing the virtual-locker system, for example, a storage room, closet or cabinet, and configuring the secured access system to permit only those recipients having an active access code allowed entry into the secured access area (storage room, closet, or cabinet). User authentication to verify access credentials are further discussed below.

FIG. 7 is a perspective view of a virtual locker form factor 700 illustrating a plurality of IoT sensors configured for use. The plurality of IoT sensors 702, 704, 706, 708, 710, and 712 serve as package sensors and are arranged at a pre-arranged distance and viewing angle along shelves 714, 716 and 718 to provide a high probability of detecting any package of even modest size placed on a shelf. Packages placed on top of others will be detected by the sensor's ability to measure the distance to an object up to a few feet away.

One or more package sensors 702, 704, 706, 708, 710, and 712 will sense the presence of a package 720 as it is placed on shelf 718 and confirm placement/delivery to the courier with a visual LED or audible tone. In FIG. 7, for example, a plurality of package sensors 702, 704, 706, 708, 710, and 712 would be located along each shelf 714, 716, and 718 in the virtual-locker. Each package sensor 702, 704, 706, 708, 710, and 712 is configured to scan a defined volume of space 722, thereby defining a virtual-locker locker compartment, which in some embodiments comprises a square prism or oral area located virtually above shelves 714, 716, and 718. The package sensors 702, 704, 706, 708, 710, and 712 are configured to determine if the available volume had changed from a previous scan, and report the data to a local, locker control unit (also referred to as an “on-board controller”). In the embodiment shown, the plurality of package sensors 702, 704, 706, 708, 710, and 712 is configured such that the package sensors are placed at a frequency determined by a vertical space between an upper shelf and a lower shelf and the expected accuracy of the package sensors. In another embodiment, the package sensors may be located on the backside of each shelf and positioned to detect packages between a user at the front of the virtual-locker and the aft of the shelf. The sensors 702, 704, 706, 708, 710, and 712 may also be positioned to sense packages to the left and/or to the right of a virtual-locker locker compartment (with or without a package). In some embodiments, one or more package sensors are configured to monitor use of a cuboid in one to three dimensions, as needed for accuracy.

FIG. 8 is a side view of a virtual locker system. When the virtual-locker system 800 is used for secured asset transfer, the system administration application is configured on a computer 802, which may have a display 804. The system administration application may send a message to the recipient that package a 806 have been delivered for them to pick up, provide the virtual-locker storage location on the virtual-locker, and permit access to the virtual-locker storage location. The recipient can then go to the virtual-locker 800, scan their authentication credential such as an ID card or QR code from their mobile phone, and then retrieve their package 806 off the virtual-locker shelf or shelves 808, 810, and 812 after their authentication credential is accepted. In some embodiments, an I/O device at the virtual-locker will display the shelf location, and an LED indicator located proximate to the shelf will turn on to visually indicate the shelf location. The system administration application of the secured asset transfer system may optionally notify the courier if the courier attempts to place a package on the wrong shelf; and it may optionally notify the recipient if the recipient attempts to remove a package from the wrong shelf.

Further details of the hardware, software, and/or firmware used to implement features and functionality of a virtual-locker and other form factors that may be incorporated into the secured asset transfer system.

In some embodiments, an employee's corporate RFID credential may be utilized for authenticating access to a secured storage area of the personal electronic locker; other options for authentication may include a QR Code, PIN and a biometric such as a fingerprint, iris scan or even voice recognition. Two factor authentication could also be deployed, requiring the user to both scan a card and input a biometric or a PIN.

In some embodiments, the secured personal electronic locker includes one or more on-board package sensors configured to report access transactions, package present status, tamper activities, mobile device charging, and/or any number of operating parameters or status indicators according to the specific use case.

In some embodiments, a secured personal electronic locker may be physically secured within a remote worker's residence. Conversely, other enterprises may want the secured personal electronic locker to be mobile. Security of both a mobile and physically secured electronic lockers may be derived from both structural integrity and by a combination of electronic IoT sensors, actuators, and software management tools. For example, in some embodiments, the sensors are configured to detect physical attacks, failed access attempts, and GPS location of the personal electronic locker. In some embodiments, some or all of the sensors could be active or inactive at any time.

In some embodiments, the locker management application is incorporated into an electronic locker system that employs an internal serial network with multiple compartments, and includes a computerized locker control unit with an application programming interface to enable communication with a remote server over the dedicated local network or the Internet using a virtual private network (VPN). In other embodiments, the locker management application may be incorporated into an electronic locker system that includes multiple locker compartments with locks that are hardwired to an industrial controller or similar device which in turn is connected to a local computer functioning as a locker control unit, which may be a single board embedded controller or a typical PC. In each case, the locker management application serves thereby to extend the productive life cycle of the physical lockers by supporting multiple use cases within the same management application. The locker management system is configured to enable a convenient and easy pivot from one use case to an entirely different use case if needed when the business mission or procedures may change.

In some embodiments, the secured asset transfer system may include multiple secured locker form factors of electronic locker systems that address different user applications, as in the examples described above. In some embodiments, secured locker form factors may include: moveable or stationary electronic locker banks, individual personal electronic lockers, remote personal electronic lockers, fixed electronic lockers that may secured to the floor or mounted on a wall, virtual-locker shelf systems that may be installed in secured access areas (e.g., secured storage rooms, closets or cabinets), and mobile electronic lockers that may be mounted on wheels. The fixed and moveable lockers have a plurality of individually lockable compartments and use either traditional point-to-point wiring to control individual compartment locks or utilize a local serial communication network to control the individual compartment locks. Use of a serial network in a bank of individually lockable compartments, defining a set of locker compartments, enables plug-and-play integration of sensors to monitor conditions such as locker location, locker status, package status, detection of external attacks, and even charging status of mobile devices that may be stored within the locker compartment.

The serial network in a bank of locker compartments may be utilized to accept data input and output points at any location on the network. For example, input devices such as an RFID card reader, a keypad input, a biometric scanner or a barcode reader could be added to reduce wait times if a queue was formed at peak use times. In place of running a cable back to the head end locker control unit, or PC, as would be required with a conventionally wired system, the input device could simply be plugged into a connector located anywhere on the existing locker network at a convenient location.

The individual locker compartments include one or more IoT package sensors configured to generate a package verification signal indicating that a package is actually placed within or removed from a locker. Additional IoT sensors may be integrated in a plug-and-play fashion, and may include temperature sensors, sensors to monitor charge status of devices connected to charging stations (e.g., via USB) integrated with the individual locker compartment, global positioning sensors (GPS), and/or sensors that detect conditions like drilling or pounding that indicate that an electronic locker may be under physical attack. Multiple IoT package sensors (such as, for example, time-of-flight sensors) can also be configured to estimate the size of a package placed in a locker compartment; for example, sensors may be placed in two or more locations within the locker compartment to determine the approximate height of package. Measuring package size is valuable because the data can be used by the software to determine the volume of “available” space that could be reclaimed by, for example, a reconfiguration of the locker bank in a stationary locker system to include a different combination of locker compartment sizes for more efficient utilization of a stationary locker system. In addition, promptly determining the height of an item placed in a locker compartment could be used as feedback to inform the user that they could have used a smaller locker, or even provide them with the opportunity to move the item from a larger compartment to a smaller compartment.

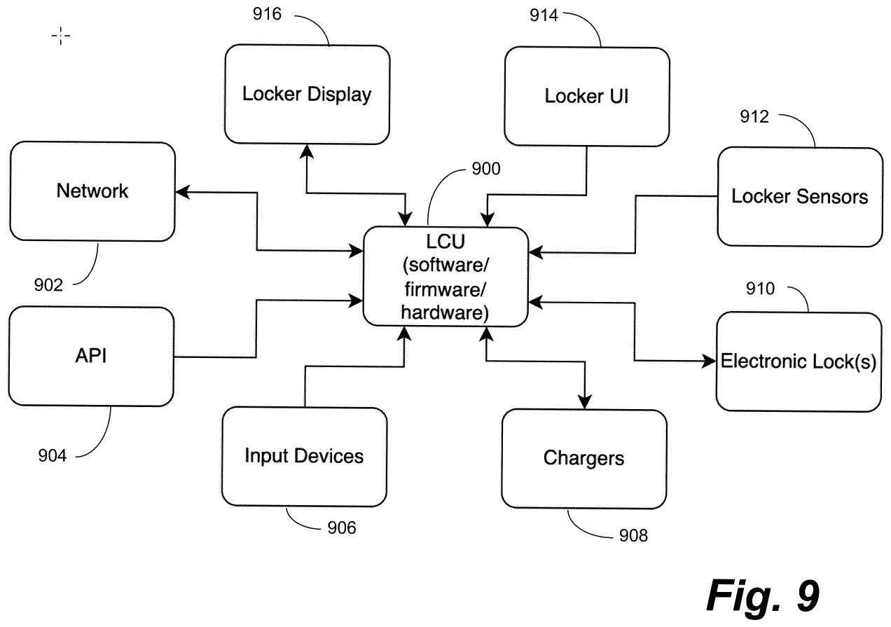

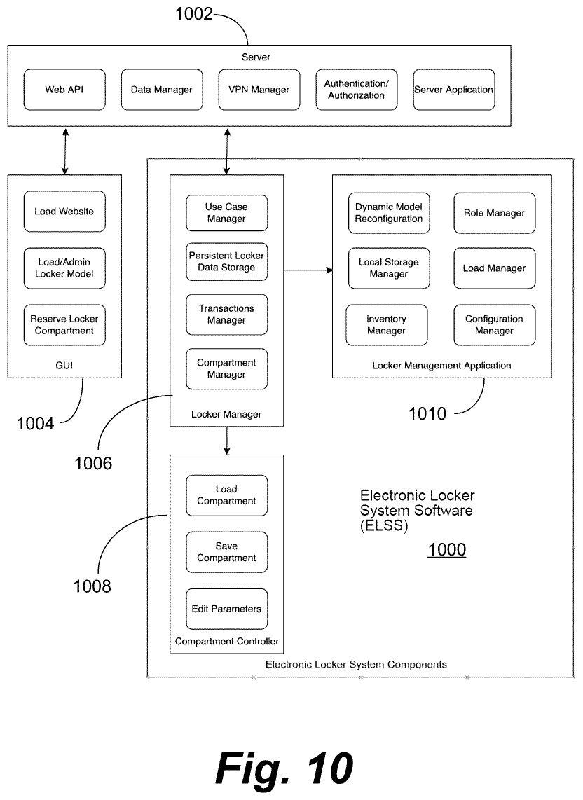

FIGS. 9 and 10 illustrate one embodiment of the software/firmware and hardware architecture that may be used in the secured asset transfer system. FIG. 9 is a schematic diagram of example generic features of an electronic locker system included in the asset transfer system. FIG. 10 is a schematic diagram of one embodiment of (1) a server-side system administration application (software) configured to manage an electronic locker system of a secured asset transfer system, (2) related aspects of a locker management application for the electronic locker system, and (3) interactions between the two, including a graphical user interface for users of the secured asset management system.

FIG. 9 shows one embodiment of an electronic locker system hardware architecture that may be used in the secured asset transfer system. In this embodiment, the electronic locker system includes a locker control unit (LCU) 900 comprising: (a) hardware, including a locker processor and persistent locker memory/data storage; (b) software, including a locker management application operable to monitor and control access to at least one electronically securable locker compartment of the electronic locker system and determine a set of locker usage data for the locker compartment; and/or (c) associated firmware providing control functionality to the electronic locker system. In the embodiment shown in FIG. 9, the LCU 900 is configured to receive from a network 902 a data set associated with operating a locker compartment, where the data set comprises a set of locker operating rules and set of pending locker transaction data. The LCU 900 is further configured to operate in communication with, and may be informationally coupled to: (a) an application programming interface (API) 904, which allows external hardware devices to communicate with the LCU 900; (b) one or more various input devices 906, such as, for example, a bar code reader or other form of scanner; (c) one or more electronic device chargers, such as for example, a USB port configured to have chargers 908 an external electronic device (e.g. mobile phone; tablet) and inform the LCU 900 when the external electronic device is connected and its charge status; (d) one or more electronic locks 910 comprising locker door sensors 912 and locking mechanisms, which provides and ensures a secured status of the electronic locker system; € locker compartment sensors 912, such as IoT package sensors (as described above); (f) a locker user interface (UI) 914, such as a control panel, as further described below; and (g) a locker display 916, which may include a touchscreen for user inputs as a component of the locker UI 914. The LCU 900 is configured to control operation of an electronic locker system in a standalone mode to function independently of a network when a communication link to the network is not available. The architecture of FIG. 9 is configured for use across a plurality of electronic locker system form factors and use cases that may be simultaneously incorporated into a secured asset transfer system, as further described below.

FIG. 10 shows a schematic diagram of a software/firmware application system architecture for one embodiment of the secured asset transfer system. In the embodiment shown, the application system comprises several general components, including: (1) a graphical user interface (GUI) running external to the server system; (2) server system software configured to execute at the server system; and (3) an electronic locker system software (ELSS), configured to execute at the electronic locker system. In the embodiment shown, the GUI and ELSS are informationally coupled to the server application over one or more secured communication links.

In the embodiment shown in FIG. 10, the GUI comprises modules that are displayed to an administrator, supervisor and/or manager monitoring use of the secured asset transfer system, as further described below. Also, in this embodiment, the server system software comprises multiple cloud-based modules for managing locker data analysis and data storage and API endpoints, a virtual private network (VPN) manager, a module for user authentications and administrator-supervisor-manager authorizations, and a server application (also referred to as a system administration application) configured to identify and record user requests for one or more form factors associated with the electronic locker systems (and selected from a plurality of locker form factors) included in the secured asset transfer system, and to perform other locker administrative tasks, such as processing the set of locker usage data to dynamically update locker profile information, and facilitate reconfigurations of the electronic locker system based upon the locker profile information.

FIG. 10 is a block diagram of the Electronic Locker System Software (“ELSS”). The ELSS 1000 operates on server 1002 having a graphical user interface 1004. The ELSS 1000 comprises (in-part):

Locker Manager 1006: Modules that handle locker-layer activities, e.g. logging, health monitoring, locker form factor management, etc.; includes a use case manager module (single or composition of uses; various forms of asset transfer); persistent locker data storage module; transactions manager module; and a compartment manager module that handles compartment-layer activities.

Compartment Controller 1008: Modules that manages activity at the level of the locker compartment hardware.

Locker Management Application 1010: Modules that configure various parameters of the electronic locker system, such as i.e. splitting locker bank into various use cases, and assigning roles for asset transfer (e.g. me-to-me user; courier; me-to-you users; etc.). The Locker Management Application includes a local storage manager module. A load manager (also referred to as a logistics module) is also included in the Locker Management Application to help balance locker allocations/assignments of locker compartments, based upon user requests, enterprise needs, and/or individual user priorities. In some embodiments, the Locker Management Application further includes a configuration manager module to implement electronic locker reconfigurations (where a default configuration of locker compartments is based on locker use case or can be set by user, and locker use data, saved via events to the Data Manager Module of the server system, can be stored and processed over time, to facilitate reconfigurations of the electronic locker system locker compartments based historical use). In some embodiments, a dynamic reconfiguration module is included to facilitate locker compartments for the electronic locker system.

In one embodiment, the system administration application is an entirely cloud-based “Software-as-a-Service” application accessible to an enterprise via an application programming interface; that may operate over a virtual private network and/or locally at the electronic locker system. The system administration application is a software application configured to manage and administer multiple hardware form factors and one or more use cases. The system administration application is also configured to readily adapt to manage multiple use cases and simultaneously operate multiple form factors with those multiple use cases. As further described below, the system administration application is configured to administer and record all settings, transactions, locker profiles, locker usage and the like, associated with multiple locker form factors, whether those form factors are based on conventional hard-wired industrial controllers or IoT network-based serial communication.

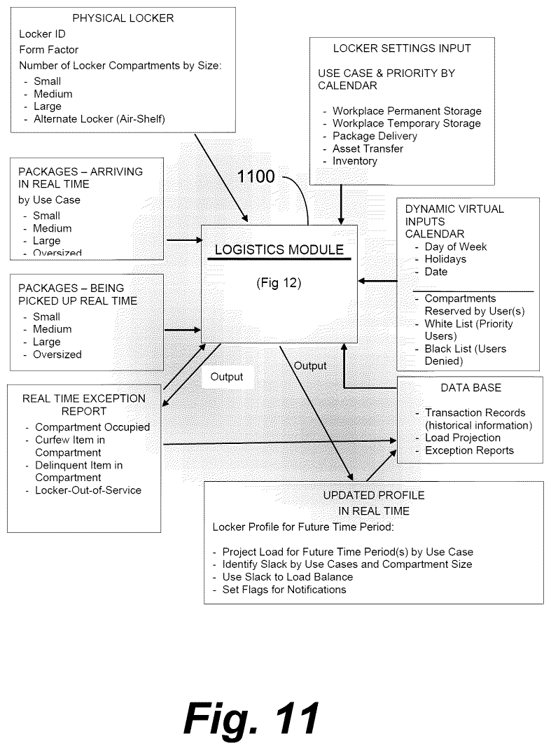

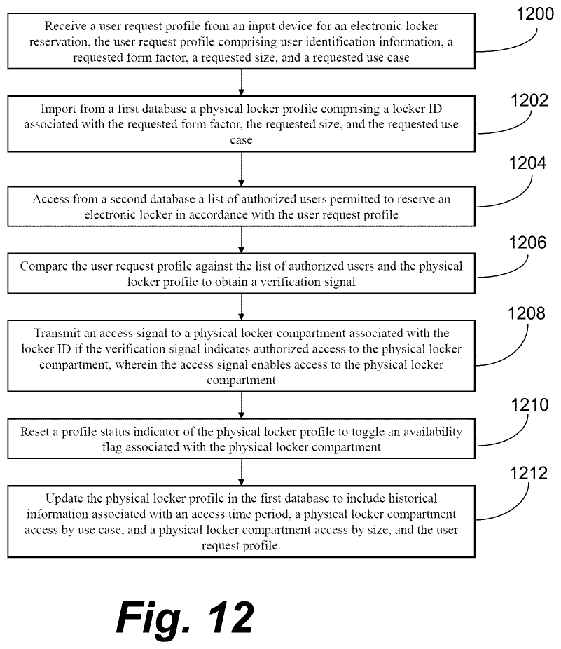

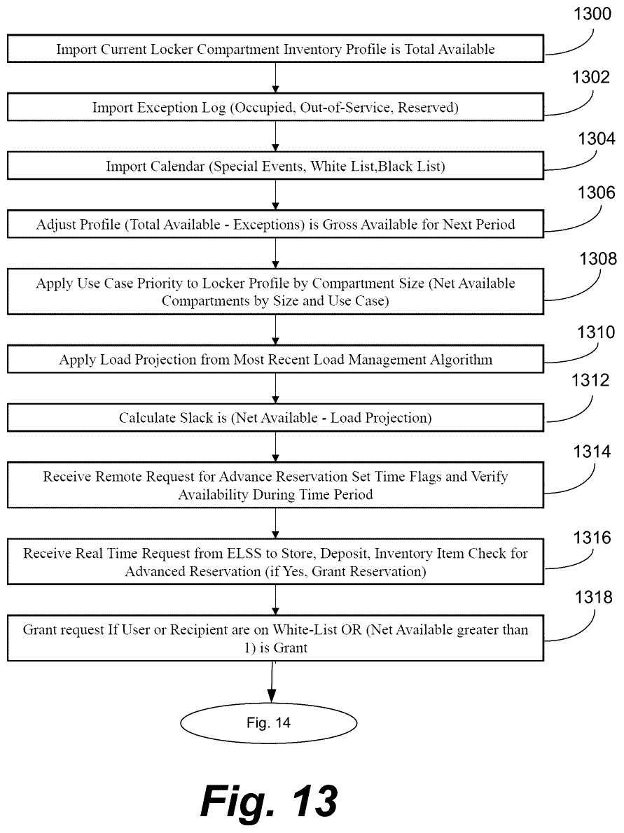

FIGS. 11, 12, and 13 show various software steps illustrating the process for an embodiment of the secured asset management system. FIGS. 11 and 12 illustrate the process steps of an embodiment of the locker management application for an electronic locker system. FIG. 13 shows process steps of the server application operating in communication with the locker management application of FIGS. 11 and 12. FIG. 11 shows various inputs, some of which are optional, that may be included in the locker load manager module described above. FIG. 12 illustrates process steps where a user requests access to an electronic locker system locker compartment. FIG. 13 illustrates a more detailed flowchart showing higher-level locker compartment allocation and assignment processes that include load balancing aspects of the server application (a.k.a. system administrate application), incorporating functionalities such as dynamic locker reconfiguration and locker reservations for future use.

A system administer that includes setting multiple levels of central operators and assigning roles and privileges to each level. Lockers can be administered by region, city and/or facility and by form factor. Various access credentials can be used and the application API can integrate with corporate physical access systems and backend human resource systems to eliminate the need for direct enrollment into the locker management system. Functionality includes removing authorized users should they be removed from the corporate access control system, the human resources system, or any other specific system of record for access. The application also supports use of multiple access credentials, both permanent and temporary, that a user may have in their possession. In some embodiments, the system administration application may also have the capability to support industry standard SAML single-sign-on protocols.

The system administration application may be configured to control a number of functional tasks. For example: opening individual locker compartments; taking them off-line; putting them back on-line; displaying alerts for tamper and low battery; and displaying overtime conditions where a user has not dropped off or picked up packages.

In addition, the system administration application may support a self-registration of personal pedestal locker and work-at-home safe-box lockers. For example, one or more personal electronic lockers may be shipped to an assigned person's residence without being first personalized at the enterprise level. The enterprise may provide a temporary one-time-use token in the form of a pin code or a bar code or an NFC code to enter into a personal electronic locker that has been shipped to an at-home employee. The personal electronic locker would then perform an internal self-check to verify it was being accessed by the assigned user. A user authentication module may be configured to utilize private key or public key cryptography for key-verification.

In some embodiments, access transactions can be searched by locker compartment, by individual locker user, and by date and time. In addition, in some embodiments, events and alerts are managed by type such as tamper, low battery, and/or door left open, and such events and alerts can be cleared by an operator of the system administration application. In some embodiments, alerts can be sent to individual locker users and system administration operators by email or by text message.

The system administration application supports multiple use cases as discussed above. In certain combinations of use cases including individual compartment reservations by users, “late notices” if a user is late to pick up an item, controlling the number of compartments a user can utilize at one time, time-stamped assignment of a locker by an administrator, assignment of a locker for a defined period of time and similar access control privileges can be applied. In some embodiments, the locker management application can further provide management of designated items that are to be inventoried in a specific locker compartment for an unknown period of time. To assure the designated item is placed in a known locker compartment, in some embodiments, the item's existing bar code label, which may be generated by the manufacturer or shipper, is read into the locker management application by a bar code scanner connected to the locker management application. If a bar code does not exist previously exist, in some embodiments one may be generated by the locker management application for the specified item and then attached to the item or its packaging. In some embodiments, a locker compartment may also be reserved by the system administration application operating in concert with the locker management application, such that when the item's bar code is scanned at a locker bank, the correct locker compartment will be opened for the item to be deposited. When a user, such as a customer or a field technician, requests access to the specific item, the system administration application operating in concert with the locker management application may be configured to provide a number of functions, which may include:
an email or text with a bar code and a backup alphanumeric code that will open the specific locker compartment containing the designated item. The software can then generate real time or periodic reports for the system operators to determine what items may need to be replenished at the specific lockers, including:
QR code generation
Print barcode shipping labels
Scan and validate product serial number
Search stock items by geolocation
Show items by distance and travel time
Reserve a Locker by Bar Code
Auto restock locker by barcode
Generate restock reports
Generate activity reports
Send reports via email
Send reservations via email
Send reservation via text message
Show directions via Google Maps
Retrieve items by QR code

The system administration application is configured to operate in concert with a locker management application for each electronic locker system that may be configured by and included in the secured asset transfer system, regardless of form factor. The system administration application may be configured to include, for example: receiving updates from a backend system via a locker system API; monitoring access transactions and other events happening at the electronic locker system; and logging information for analysis or for sending to a host information technology (IT) system. In some instances, there may be an occasion when the communication link between the software administration application and a locker management application for an electronic locker system may be interrupted-such as, for example, if Internet connectivity fails or a network connection is intentionally switched to off-line. In such instances, in order to maintain functionality of the locker hardware systems while off-line, in one embodiment, a control unit in each electronic locker system, regardless of form factor, is configured to maintain a local record of the most recent set of operating rules and pending transactions for the one or more secured locker compartments, stored in a persistent locker data storage; such operating rules may include, for example, a use case profile and the specific authorizations and access restrictions pertaining to each such off-line secured locker compartment, such that most, if not all access transactions can be conducted properly. In addition, in one embodiment, a computer processor included in each form factor is further configured to maintain a local log of all transactions, which may be uploaded to the system administrative application when connectivity between the system administration application and the locker management application is restored.

Problematic aspects of conventional electronic locker systems may be avoided by the implementation of the secured asset transfer system. Consider that with conventional hardwired electronic lockers, information provided by a conventional locker bank is limited to sensing individual door openings and closings by a switch that is located on a lock device, and there is no practical way to detect whether or not an item has been inserted into or removed from an individual locker compartment. In a workday use case, one employee could reserve a conventional locker compartment for the day, open it once, but never actually store an item while keeping it reserved for the day. In this scenario, the conventional locker compartment would go unused for the day, but management would not know.

Similarly, an employee could store an item in a conventional electronic locker but not pick it up at the end of the day, leaving the conventional locker system unable to determine if the locker compartment is empty, so that it may be released for use by another person, or still in use and not available for release/use the following day. In either situation, the locker compartment is not available, thus preventing another employee from using it. If, on the other hand, a locker compartment is released for a reserved use on a following day with un-retrieved items of the previous employee, the premature release of the conventional locker compartment potentially exposes the previous employee's un-retrieved personal items to the next person who is assigned the same locker compartment on a following day.

As another example of problems arising with conventional electronic locker systems, in a package delivery use case or an inventory use case, a courier could simply open a locker compartment door but not deposit a package, or a recipient could open a locker compartment door, take a package, and report there was no package. In either case, there is a dispute with no data to help form a resolution.

While the above scenarios may seem to be small problems, an enterprise with thousands of transactions per week will certainly wish to avoid them if at all possible, with a more intelligent electronic locker management system that can accurately monitor actual use and availability of secured locker compartments.

The potential for error described above is avoided in the secured asset transfer system, which includes package sensors (e.g., time-of-flight sensors, cameras) configured to monitor the presence of an item in the locker compartment. These package sensors generate inputs to alert the system administration application that a locker compartment does or does not have an item present. This information can be used by the system administration application to prevent release of a locker compartment to an available pool of assignable lockers, and instead notify the previous user that they may have left an item in the locker compartment the previous day. The information can also be used to resolve disputes regarding whether or not a package was placed in or removed from a locker compartment, providing accountability.

In some embodiments, additional sensors may be integrated in a plug-and-play fashion within an electronic locker system and/or individual locker compartments, including, for example, temperature sensors, charge status sensors incorporated with devices that provide charging of mobile electronics (phones, tablets, etc.) by USB and monitoring of charge status, global positioning sensors (GPS), and accelerometers that detect conditions like drilling or pounding that indicate that an electronic locker may be under physical attack.

In some embodiments, the charging of electronic devices is supported in an electronic locker system by using available power on a serial network without requiring additional wiring. There may be use cases, for example with asset transfer or secure storage, where electronic devices may be stored with a need for recharging. In one embodiment, the secured asset transfer system includes circuitry to determine if an ancillary electronic device stored in a locker compartment, such as a smart phone, is near fully charged, and to inform the user when the device is reaches the near fully charged condition.

In some embodiments, one or more package sensors are configured to estimate the size of a package placed in a locker compartment of a wall locker having a plurality of locker compartments. In one embodiment, for example, package sensors are located at one or more locations within a locker compartment to obtain information sufficient to determine the approximate height of a package placed inside. A first sensor can determine if a package is present, and a second can determine if the package is of a size to require the compartment or could be fitted into a smaller compartment. In such embodiment, the first sensor is configured to determine that a package is present, and the second sensor is configured to estimate a size of the package in relation to a compartment size. Measuring package size is valuable because such data can be used by the secured asset transfer system to estimate the volume of unused locker compartment space that could be reclaimed with more efficient utilization. For example, small items like a laptop or a purse placed in a large locker would be a waste of space when a small compartment could have been selected. Data collected and analyzed by the system administrator application is useful to identify needs for better communication to the locker system users. Alternatively, it is possible that all of the small compartments were being used so the larger compartment was selected. This would indicate a need for additional small lockers in the electronic locker system configuration. Data collected and analyzed by the system administrator application regarding package size is useful to improve design configuration of lockers for similar use in the future.

In addition to locker and package sensors, in some embodiments, an electronic locker system comprising a bank of locker compartments includes a serial network that can accept additional data input devices located anywhere on the serial network. This capability makes it possible to add devices such as keypads, barcode scanners, RFID and NFC scanners. This aspect is of value whenever there is a persistent queue of users who are anxious to access or deposit their items-additional authentication stations enable quicker transaction times at the locker bank.

For example, in some embodiments, a network cable will have a plurality of connection points located to enable future additions of one or more Internet-connected devices, such as, for example, an RFID card reader, a keypad, a biometric reader or a bar code reader. Such optional feature is particularly useful when additional locker compartments are added to a locker bank of a stationary locker system, or when users grow in number, thus creating a queue at the current input devices. This could happen, for example, in the morning when people arrive at the office, when people plan to take lunch, or when people are ready to leave the office. It could also happen during the periods when the large courier services arrive to deliver packages and when employees rush to pick up their packages after notification.

For example, in the case of an electronic locker system, and in some embodiments, a standard connector may be installed at a locker compartment, or at any point where the network cable has an interface to accept a second network cable, such as at an expansion board for additional lockers and components. Such embodiments would be equivalent to placing “network drops” at various locations in a building, even though there may not currently be a requirement for many of the locations. In such embodiments, at any one of the points where a port or a connector were installed, an Internet-connected input device could be added in the future, as needs arise. For example, in some embodiments, if additional locker cabinets were needed at a bank of lockers, a network cable in a new locker bank would have a mating connector configured to plug into an opposite-sex connector on the already installed bank of lockers. In such embodiments, a need for an additional data input device to the new or existing bank of lockers would be met by adding the additional input device at any location on the network where an available connector was located. In some embodiments, on a locker bank, this location may be positioned at the top or bottom of the electronic locker system's structure, aligned with one of the locker compartments, or on a vertical member such as a locking stile that is often used to provide a keyed override to the locker compartments in a column of locker compartments.

### Data Capture and AI Analysis

As mentioned above, the system administration application optionally includes functionality to capture data over time and to process that data to predict future demand profiles for locker compartments for one or more use cases. Since use cases can be considered as competing for locker compartment availability, and by considering the demand forecast for each use case, an optional optimization module of the secured asset transfer system can significantly improve utilization of an electronic locker system, and thereby the return on investment in the electronic locker system.

FIG. 11 shows one embodiment of a locker load module of the system software architecture. The locker load module processes one or more inputs, such as a physical locker profile, use case request, user ID or other authentication/access credential, etc., and then generates an output comprising at least one physical locker profile for configuring and/or operating at least one locker compartment during an upcoming period for an authenticated user; in some embodiments, this may be accomplished given the load status and projected demand for locker components and/or electronic locker systems based on historical data.

In some embodiments, an historical data period could be, for example, minutes, hours, work periods or some other defined period. In some embodiments, the locker management application is configured to evaluate historical data given the day-of-week and projected demand, use case priorities and event-driven inputs. In some embodiments, the locker management application is configured to provide secondary recommendations to a user of the secured asset transfer system, such as better training of users, a change in the number and size of locker compartments, and/or alternative choices of form factors.

FIG. 11 illustrates one embodiment of the locker management application of the secured asset transfer system. In some embodiments, the locker management application is executed on a locker processor for an individual locker compartment; in other embodiments, the locker management application is executed on a locker network processor for an electronic locker system.

In some embodiments, the locker management application includes a logistics module 1100 (a.k.a. load manager module) configured to capture data over time as historical data; in such embodiments, the locker management application is configured to process the historical data to enable or facilitate prediction of future demand and availability for electronic locker system resources, including, for example, electronic locker compartments for one or more use cases and locker compartment sizes. Use cases can be considered as competing for locker compartment availability and allocation, such as, for example, between multiple retailers who share an electronic locker system installation, or between departments within an industrial enterprise who have different use cases. By forecasting future demand for each use case, the locker management application of the secured asset transfer system can significantly improve the management and utilization of locker resources and thereby the return on investment in the electronic locker system.

In some embodiments, as and shown in FIG. 11, inputs to logistics module of the locker management application, as shown in the central block of FIG. 11 and detailed in FIG. 12, including for example:
A PHYSICAL LOCKER PROFILE (input from the ELSS)
Locker ID
Form Factor
Number of Locker Compartments by Size:
   Small
   Medium
   Large
   Alternate Locker (Air-Shelf)
LOCKER SETTINGS INPUT—USE CASE & PRIORITY BY CALENDAR (input from the systems administration application)
   Workplace Permanent Storage
   Workplace Temporary Storage
   Package Delivery
   Asset Transfer
   Inventory
DYNAMIC VIRTUAL INPUTS CALENDAR (input from the system administration application)
   Day of Week
   Holidays
   Date
   Compartments Reserved by User(s)
   White List (Priority Users)
   Black List (Users Denied)
   Special Events
   Next Time Period
   Set Low Level Alert Parameter
PACKAGES—ARRIVING IN REAL TIME (by use case) (input from the ELSS)
   Small
   Medium
   Large
   Oversized
PACKAGES—BEING PICKED UP IN REAL TIME (input from the ELSS)
   Small
   Medium
   Large
   Oversized
DATABASE (input from Persistent Locker Data Storage Module of the ELSS)
   Transaction Records (historical information)
   Load Projection
   Exception Reports

In some embodiments, and as shown in FIG. 11, the locker management application communicates usage information to the ELSS and system administration application for further processing, such as (for example):
REAL TIME EXCEPTION REPORT
   Compartment Occupied
   Curfew Item in Compartment
   Delinquent Item in Compartment
   Locker-Out-of-Service
UPDATED PROFILE IN REAL TIME
Locker Profile for Future Time Period:
   Project Load for Future Time Period(s) by Use Case
   Identify Slack by Use Cases and Compartment Size
   Use Slack to Load Balance
   Set Flags for Notifications

FIGS. 12 and 13 are flowcharts describing locker assignment and load balancing methods (respectively) for some embodiments of the secured asset transfer system. FIG. 12 illustrates one embodiment of a locker management application for assigning a locker compartment to a user of an electronic locker system. In some embodiments, such as the embodiment shown in FIG. 12, the entirety of the steps is to be performed by the logistics module as executed by the locker management application. Locker assignment and load balancing methods generally include receiving a data set representing operating rules associated with operating the locker compartment (e.g., user priorities, and as described below), and some embodiments also include receiving a data set representing pending locker transaction data.

More precisely, one or more modules of the electronic locker system software (ELSS) is configured to: (a) receive a data set associated with operating a locker compartment and representing (i) a set of locker operating rules and (ii) a set of pending locker transactions; (b) store the set of locker operating rules data and the set of pending locker transactions in the persistent locker data storage associated with the locker compartment—the locker operating rules includes a use case profile and user access credential used by the ELSS to authorize access to the locker compartment, the use case profile comprises information derived from a plurality of use cases, and the set of pending locker transactions includes access data relating to at least one request for access to the locker compartment; (c) maintain a log of locker transaction data in the persistent locker data storage during operation of the locker compartment; (d) upload to the server system the log of locker transaction data when the server system is capable of electronic communication with the electronic locker system; and (e) update the locker profile to include transaction data pertaining to the access request. In such embodiments, when the transaction data is uploaded, the electronic locker system is configured to update the log of transaction data to an actual status and then apply a logistics module (executing a load management algorithm) to reflect an updated locker profile for a next period of time. In some embodiments, the ELSS is further configured to one or more alerts to one or more locker compartment users and/or operators of the secured asset transfer system (e.g., administrators, managers, supervisors) depending on any Flags for Notification that may be set in the LCU.

FIG. 12 is a flow chart of the process steps of the ELSS. In step 1, the ELSS receives a user request profile from an input device where the user request profile comprises user identification information, a requested form factor, requested size, and a requested use case 1200. In step 2 the ELSS imports from a first database a physical locker profile comprising a locker ID associated with the requested form factor, the requested size, and the requested use case 1202. In step 3, the ELSS accesses from a second database a list of authorized users permitted to reserve an electronic locker in accordance with the user request profile 1204. In step 4, the ELSS compares the user request profile against the list of authorized users and the physical locker profile to obtain a verification signal 1206. In step 5, the ELSS transmits an access signal to a physical locker compartment associated with the locker ID and if the verification signal indicates authorization access to the physical locker compartment where the access signal enables access to the physical locker compartment 1208. In step 6, the ELSS resets a profile status indicator of the physical locker profile to toggle an availability flag associated with the physical locker compartment 1210. In step 7, the ELSS updates the physical locker profile in the first database to include historical information associated with an access time period, a physical locker compartment access by use case, and a physical locker compartment access by size, and user request profile 1212.

FIG. 13 is a flow chart of the process steps of the system administration application. In step 1, the system administration application imports the current locker compartment inventory profile and whether it is available 1300. In step 2, the system administration application imports an exception log (e.g., occupied, out-of-service, or reserved) 1302. In step 3, the system administration application imports a calendar with special events, whitelist and blacklist 1304. In step 4, the system administration application adjusts the profile with the total available exceptions is gross available for the next period 1306. In step 5, the system administration application applies use case priority to locker profile by compartment size according to the net available compartments by size and use cases 1308. In step 6, the system administration application applies load projection from the most recent load management module 1310. In step 7, the system administration application calculates slack such as the net available and load projection 1312. In step 8, the system administration application receives remote request for advance reservation set time flags and verifies availability during the time-period 1314. In step 9, the system administration application receives a real time request to store, deposit, inventory item check for advanced reservation and if yes, grant the reservation 1316. In step 10, the system administration application grants the request if the user or recipient is on the whitelist or the net availability is greater than one 1318.

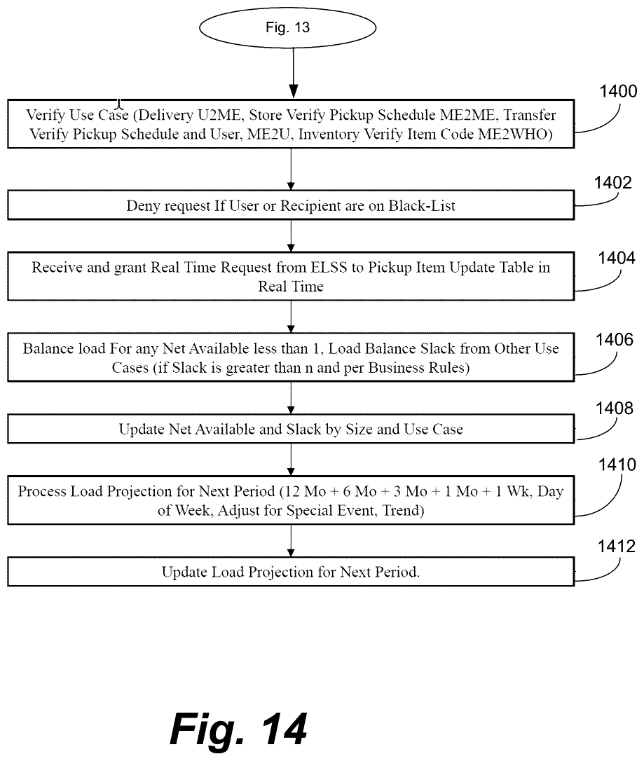

FIG. 14 is a flow chart of the process steps of the system administration application. In step 11, the system administration application verifies the use case such as deliver U2ME, stores the verify pickup schedule ME2ME, transfers the verify pickup schedule and user, ME2U, and inventory verify item code ME2WHO 1400. In step 12, the system administration application denies the request if the user or recipient is on a blacklist 1402. In step 13, the system administration application receives and grants the real time request from the system administration application to pickup asset and updates the table in real time 1404. In step 14, the system administration application balances the load for any net availability less than one, with the load balance slack from the other use cases if the slack is greater than “n” and per the business rules 1406. In step 15, the system administration application updates the net available and slack by size and use cases 1408. In step 16, the system administration application processes the load projection for the next period and adjusts for any special events or trends 1410. In step 17, the system administration application updates the load projection for the next period 1412.

In some embodiments, usage information communicated from the locker management application to the system administration application is stored in a database of transaction records and load projections at the server system of the secured asset transfer system. Such usage information may be used at a later time as input to the logistics module, as shown in FIG. 11.

In some embodiments, historical data can be analyzed with respect to the existing real-world physical locker configuration, virtual-world parameters such as time of day and day of week, use cases, business rules that set priorities, and dynamic factors such as planned business events, workday policies, vacation schedules and similar factors. Such optional features, which in these embodiments are incorporated into the set of operating rules, are beneficial as employees follow a hybrid work schedule. Operating rules are received by the ELSS and stored locally at the electronic locker system to define the privileges and restrictions on a user or group of users for the locker compartments, such as their priority based on use case, the length of time they are permitted to have access to an electronic locker system and/or locker compartment, the size of locker compartment and whether or not they are on a whitelist (“always”) or a blacklist (“never”). Operating rules, in some embodiments, are established by an administrator, manager or supervisor of the asset control system and/or electronic locker system.

In some embodiments, operating rules enable procedures to load balance the locker compartments of an electronic locker system, as further described below. Locker usage data collected and analyzed in such embodiments of the asset transfer system provides valuable information that may be used towards optimizing daily capacity by use case, form factor, location, configuration and other parameters that would be of value to most any organization. For example, an industrial distributor, a university research center, a government agency or a retailer may not have the same business policies and procedures, making it more important to create an electronic locker operational model that aligns with an organization's needs as time marches forward and those needs change. Each organization might have different use cases and business rules to fit their business needs, policies and procedures.

Data transmitted to and from one or more input or output devices included in the electronic locker system (which devices may be incorporated into the electronic locker system via, e.g., a locker serial network) is captured by a locker server, such as a PC computer, an Intel NUC, a Raspberry Pi or embedded system on a single board computer. In some embodiments, such data may be stored on the locker processor or locker network processor (where applicable), and/or uploaded to a remote server processor and stored in a remote database. Once such data is collected and stored, the secured asset transfer system may be configured to analyze the data and provide locker usage information that may be useful to predict future net load on the electronic locker system.

Such data analysis and locker usage information can help a user of the secured asset transfer system improve locker utilization by, for example, facilitating determination of one or more beneficial locker compartment configurations for an electronic locker system or for a networked group of electronic locker systems. In some embodiments, such data analysis may be performed entirely by the locker management application of the electronic locker system; in other embodiments, it may be performed entirely by the system administration application of the secured asset transfer system; yet in other embodiments, such data analysis may be performed in part by both the locker management application and the system administrator application operating in concert.

Thus, in some embodiments, data is analyzed in the secured asset transfer system with respect to an existing real-world physical locker configuration, and/or one or more virtual-world parameters, such as: time of day and day of week, one or more use cases, business rules that set priorities, and dynamic factors such as planned business events, workday policies, vacation schedules and similar factors. Such aspects of the secured asset transfer system are beneficial to companies and their employees who follow a hybrid work schedule.

The system administration application and locker management application may also be configured to allocate locker compartment availability between cooperative partners, such as two or more retailers who share an electronic locker system. In some embodiments, locker compartments may be allocated by historical use, by special events such as sales, and/or by bidding for a higher priority based on seasonality.

Thus, FIGS. 13 and 14 illustrate one embodiment of the system administration application enables automated load balancing between use cases through actively monitoring extra capacity (also referred to as “slack”) that users of an electronic locker system may have as a result of locker demand which is less than net available capacity. In a such case, the locker management re-allocation of unused locker compartment space to another use case where demand may have exceeded capacity for a period of time.

In the embodiment shown in FIGS. 13 and 14, inputs to the logistics module are processed in accordance with steps generally depicted in FIG. 12, but additionally includes steps to generate profile information relating to how the electronic locker system may be reconfigured during an upcoming time period based on current load status and projected demand derived from projections using historical data.

The locker management application of the secured asset transfer system may also optionally provide specific data inputs to the system administration application potentially impacting demand for locker compartments and/or personal electronic lockers in the electronic locker system, such as a special workday meetings, expected increase in package delivery, or requirements to inventory items. The upcoming period could be measured in minutes, hours, work periods or some other defined period. In some embodiments, the logistics module is configured to evaluate historical data given the day-of-week and projected demand, use case priorities and event-driven inputs. In such embodiments, the locker management application and/or the system administration application may be further configured to provide, based upon such evaluations, primary recommendations to an enterprise user of the secured asset transfer system, such as sizes and quantities of locker compartments needed for specific use cases for upcoming days, and secondary recommendations such as better training of users and compartment locations.

### Personal Electronic Locker System

Similar in function to large stationary locker banks, the personal electronic locker systems are designed to physically secure sensitive hardware prototypes, laptops and other non-digital assets by utilizing advanced electronics for status monitoring and access control. In some embodiments, there are two form factors of the personal electronic locker. The larger is designed to efficiently fit into compact spaces such as under a work surface (e.g. desktop, countertop, table, lab bench), and the smaller is more compact and designed to be mounted to a wall or desktop. Either can be utilized by one or more users. The larger personal electronic locker form factor is referred to as a pedestal, and the smaller is referred to as a safe-box.

Both the pedestal form factor and the safe-box form factor are enabled to maintain specified functionality while offline (standalone) and also be connected on a local area network by a physical Ethernet connection, WiFi or Bluetooth. The pedestal locker may be designed to fit under a desk or workspace. The personal electronic locker systems can also be connected to a wide area network by 4G or 5G LTE via a cellular modem. Each form factor of the personal electronic locker is also power-over-Ethernet enabled and includes an alternative 110 Volt AC to DC power supply for use when POE is not available. The personal electronic locker may also be equipped with a rechargeable battery, enabling it to operate for a minimum number of openings over a limited time period when not connected to an external power source.

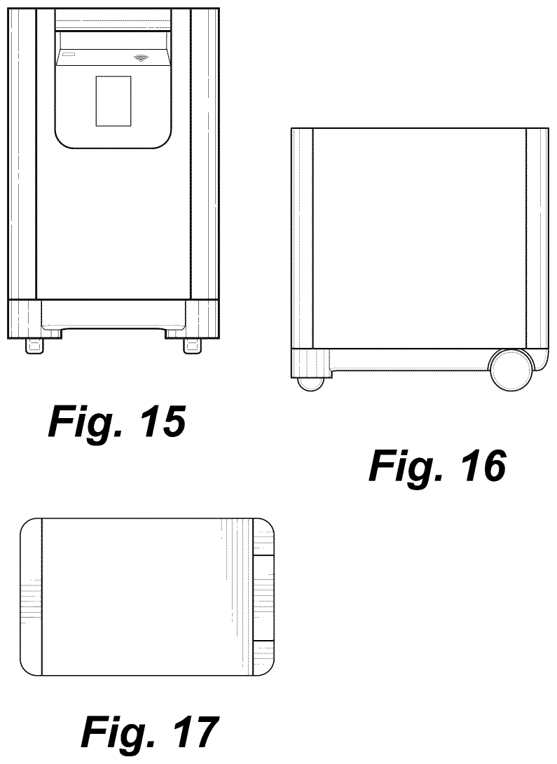

FIGS. 15 (front view), 16 (side view), and 17 (top view) collectively show one embodiment of a personal electronic locker intended for secured asset transfer for a “me-to-me” user—i.e., a single individual with a personal storage use case—and dimensioned for use alongside or below a work surface. The form factor for this form of electronic locker system is referred to as a “pedestal” form factor. In this embodiment, a pedestal form factor is designed for modern open offices and offices where the workers may be required to follow a hybrid schedule; in such an environment, a moveable personal electronic locker for individual use facilitates worker movement from location to location within the work environment. In some embodiments, the pedestal is designed to be readily mobile and is equipped with wheels, as shown in FIG. 16. In some embodiments, the pedestal is dimensioned to be easily placed below a work surface or desktop, or alternatively may be stationed beside a work surface or desktop and may serve as an extension.

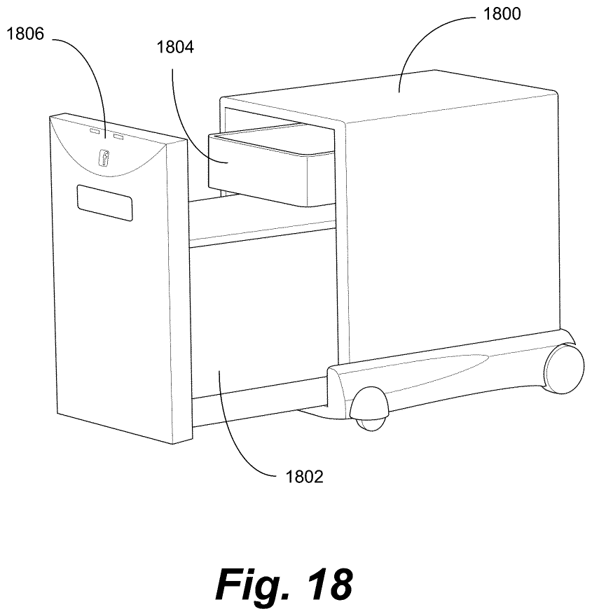

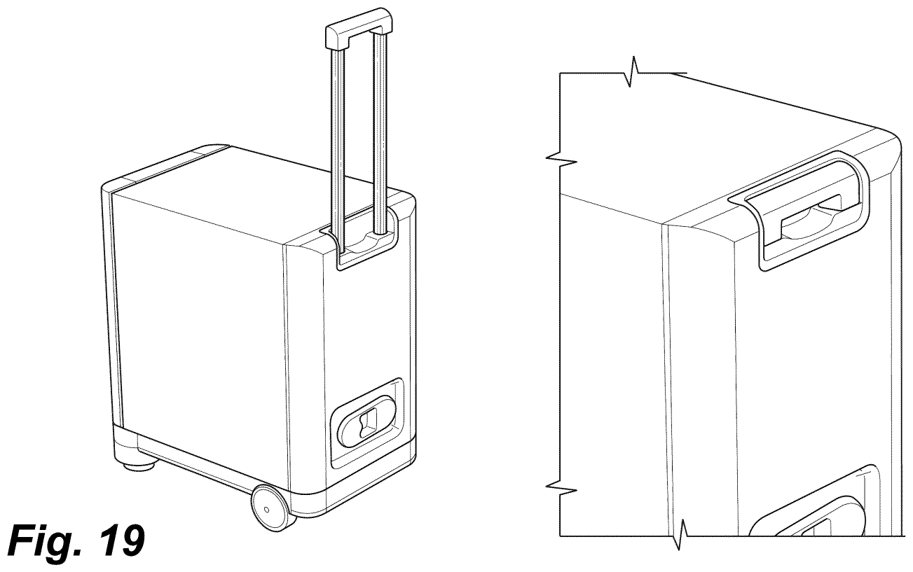

FIGS. 18 and 19 show embodiments of a secured personal electronic locker that may be classified as a pedestal form factor of the secured asset transfer system. By way of example in FIG. 18, a personal electronic pedestal locker 1800 can accommodate one or more drawers 1802. In FIG. 18, one large drawer 1802 on the bottom and a smaller drawer 1804 located above the large drawer and operating independently of the large drawer. Secured to the large drawer 1802 is a front deck module 1806 that covers each of the drawers and houses the electronic controls. When the pedestal 1800 is unlocked, pulling the front forward also pulls the bottom drawer 1802 forward to provide access. This action also exposes the smaller drawer, which can be accessed by pulling it forward. Both drawers can be closed by pushing the front deck module backward toward the rear of the pedestal, causing the drawers to move into a closed position. The lock module will then be engaged and will lock when fully closed. It is possible to have an embodiment where the front deck module does not cover multiple drawers, leaving at least one unsecured and available to be opened without electronic authentication.

In some embodiments, the outer cabinet structure of the pedestal 1800 will typically be made of cold-rolled steel but could be constructed from aluminum or structural plastic. There is a base chassis that could be made from injection-molded or vacuum formed plastic, or a composite of plastic and a metal such as steel or aluminum. The base chassis provides stability to the outer cabinet structure and it can serve for mounting of the casters and wheels on a mobile unit.

As shown in FIG. 19, the front deck optionally includes a user interface (also referred to as a control panel). In some embodiments, the user interface may include an ID card reader, bar code reader, a numeric keypad, and/or a biometric scanner. In some embodiments, a set of LED's provide system status and the results of any user operation. As shown in FIG. 19, located on the back of the pedestal is a rear deck that may be formed metal or plastic, optionally to provide a consistent industrial design form with the front deck and the base chassis. In some embodiments, and as shown in FIG. 19, the rear deck also houses a telescoping handle, similar to luggage handle, for facilitating translation of the pedestal through the workspace, as further described below.

In some embodiments, the chassis can serve as a ballast weight for stability when one or more front drawers of the pedestal are moved to an open position, which prevents the pedestal from tipping forward. Optionally, an additional ballast can be included to counter-balance the pedestal when the rear mounted handle assembly is being used to move the pedestal locker by tipping it backward to lift the front casters off of the floor. In some embodiments, and alternatively, either the chassis or the rear deck of the pedestal provide means for mounting electrical service connectors, such a low-voltage power plug and an Ethernet connector. In one embodiment, the connectors can include the breakaway configuration, which will serve to prevent damage to the connectors if the pedestal is moved far enough to cause the connectors to be stressed or pulled apart.

As shown in FIG. 18, the front deck module is attached to one of the drawers, preferably the lower drawer, and contains most of the electronic components including the main control PCB. The front deck module is made of molded or formed plastic resin, which allows for a more reliable wireless connection between the internal components and a remote transceiver. Alternatively, the front deck module can be made of formed steel or aluminum. The advantage of plastic is to facilitate wireless communication by WiFi, Bluetooth and cellular. For structural security, the rear plate of the front deck is constructed of an attack resistant material but is also light weight to reduce the potential for tipping when the front deck is moved forward to unlick. Options include an aircraft grade composite carbon fiber material or a fabricated metal sheet such as steel or aluminum.

FIGS. 18 and 19 show mechanical components for one embodiment of the pedestal electronic locker system. Referring to FIG. 18, this embodiment includes three basic mechanical compartment features:

Primary Drawer 1802. The primary drawer is the structure that slides into and out of the outer shell and is physically secured to the front deck and may be fully integrated into the front deck assembly. The primary drawer may have side-mounted or bottom-mounted drawer slides, or optionally it could have a custom designed detail that conforms to a similar detail in the outer shell to provide the slide function.

Utility Drawer 1804. The utility drawer is a small drawer that slides in and out when the primary drawer is open and is pushed inward by the primary drawer when it is closed. It operates independently of the primary drawer when it is open and can accept custom formed Inserts designed to hold specific devices that are small enough to fit in the drawer. Optionally, the utility drawer can accept different inserts which are formed to accept specific devices that are most commonly stored, thereby assisting the user to place them in the correct position. The inserts can be removed and can be replaced as devices to be stored change by size and configuration.

Pedestal Control Module (PCU) 1806. The PCU refers to the entire electronic control system in the personal electronic locker's front deck. It includes the locker control unit and peripheral components such as sensors, I/O devices, and replaceable battery back-up and can control the lock module. Some of the peripheral components may be mounted on secondary PCB's and connected to the central controller via cables. The PCU may be packaged in a plastic housing and designed be easy to replace in the field. The PCU could alternatively be located within a cabinet's outer shell, in a module designed to be mounted on the top, sides, back or bottom chassis; each of these locations would yield equivalent functionality, but the front deck provides a viable location for the electronic components for cost, manufacturability and service access.

In additional, and as shown in FIGS. 18 and 19, one embodiment of a personal electronic locker includes casters and/or wheels for ease of mobility; casters and wheels are interchangeable in terms of functionality. In some embodiments, a top surface of a steel cabinet outer shell provides a location for a horizontal accessory tray configured to hold items such as electronic devices (which may also be coupled to the personal electronic locker via one or more USB charging ports, for example), or small office supplies (e.g. pens, pencils, stapler, paper clips, tape, etc.) that are often used during the day, for convenient access.

FIG. 19 shows the backside of the embodiment shown in FIG. 18, included an expanded view. In the embodiment shown, located on the back of the cabinet is a rear deck made of formed metal or plastic that provides a consistent industrial design with both the front deck of the personal electronic locker and the base chassis. In this embodiment, the rear housing provides an enclosure to accept a telescoping handle that can be used to conveniently move the unit for moderate distances such as between workstations, meeting rooms or even further distances. The unit can be moved in this embodiment with the handle (extended or un-extended) and both the front and rear casters and wheels on the floor, or the handle can be used to tilt the unit such that only the two rear wheels are on the floor. This operation is much like using a 2-wheel hand-truck. In other embodiments, other forms of handles and wheel configurations may be used to permit the personal electronic locker sufficient mobility for the user to relocate it when desired. In some embodiments, one or more areas on the personal electronic locker may be formed integral to the cabinet to provide convenient locations of a user to safely grip the personal electronic locker while moving it.

In some embodiments, such as that shown in FIG. 19, the rear housing also includes a recessed detail that can accept storage of a power cable and an Ethernet cable; such feature serves to simplify moving the unit, by eliminating cables from dragging on the floor and becoming entangled. In some embodiments, the rear deck or chassis can also contain a set of connectors for Ethernet and for power. In other embodiments, the rear deck includes a door that opens to expose the stored cables and when closed the cables are hidden.

With hybrid work schedules affecting most organizations, employees and contractors are often required to work on sensitive projects while at home. This has created a dilemma for an organization that needs assurance that high-value non-digital assets are protected while outside of the corporate office. Some organizations have managed this risk with a policy that requires development engineers be in the office to work on sensitive items. Other enterprise firms have required their developers to sign contracts that require confidential items be securely stored when at home and not being used for company purposes. The safe devices that have been used previously for storage have no accountability tests or connectivity, so the actual security is minimal.

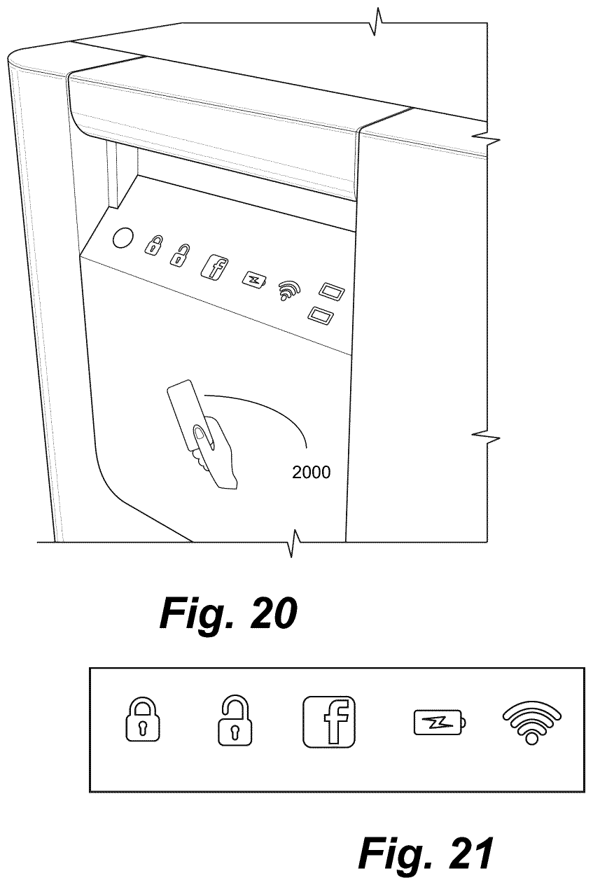

FIGS. 20 and 21 show embodiments of a user interface for a personal electronic locker of an electronic locker system. In the embodiment shown, the user interface comprises a locker control panel including: (a) an RFID card reader (which in this embodiment is located behind a decorative overlay for esthetic purposes); (b) multiple USB-C charging ports; (c) a push button On-Off switch; and (d) a plurality of indicator lamps configured to indicate system status. Other user interface configurations may be used, including a keypad for personal identification number (PIN) entry, a biometric reader (e.g. fingerprint) or QRC/mobile phone access system. An optional remote control unit 2000 can be employed to control the user interface.

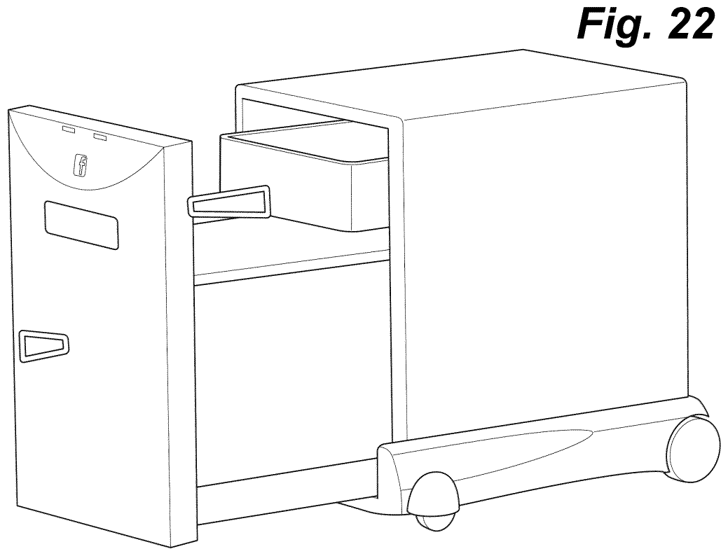

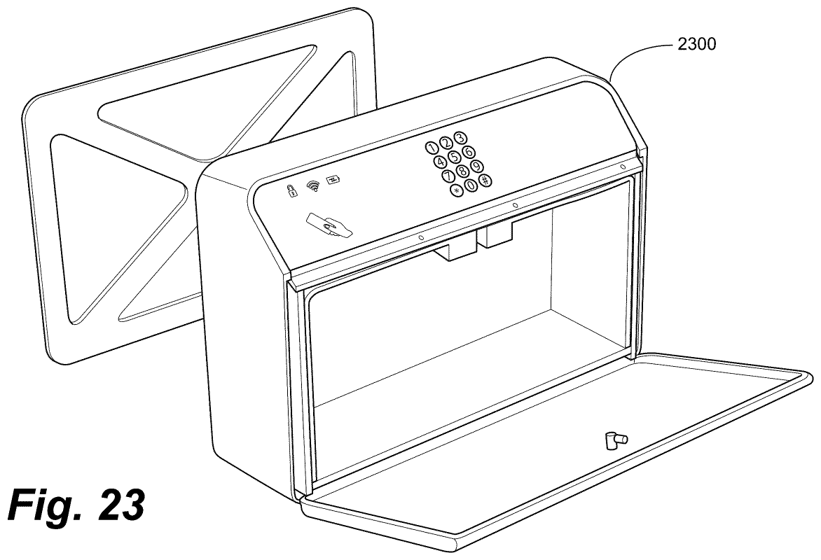

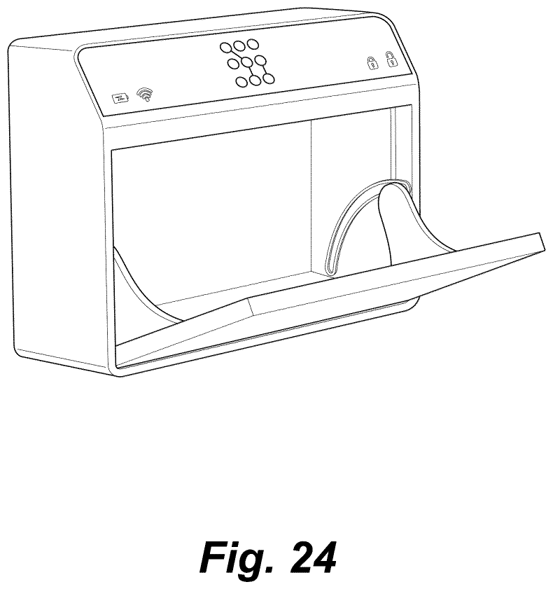

FIGS. 22, 23, 24, and 25 show three separate embodiments of a personal electronic locker of the secured asset transfer system. The examples show various electronic components for a personal electronic locker that may be included in the secured asset transfer system. FIG. 22 shows the electronic components that are included in one example embodiment of a pedestal locker form factor, and FIGS. 23 and 24 show alternative example embodiments for a safe-box locker form factor.

FIG. 22 is a perspective view of a mobile pedestal locker system. In this embodiment, a mobile pedestal 2200 includes among its electronic components auxiliary printed circuit board (PCB) an RFID card reader, and time-of-flight sensors for detecting presentation of an RFID card and for detecting stored item(s) in the top drawer 2202 and in the bottom drawer 2204. The top drawer 2202 may have a clear front for easy viewing of stored assets. The bottom drawer 2204 may be configured to secure the top draw drawer 2202. The mobile pedestal locker system 2200 may include power and data ports, types of which are known to one skilled in the art. The mobile pedestal locker system 2200 may include internal data ports, loudspeakers, GPS modules, ToF sensors that can detect presentation of RFID cards.

FIG. 23 is a perspective view of a safe-box locker system. In this embodiment, the safe box locker system 2300 shows a wall-mounted safe-box locker system. Such embodiment may be installed at home or in small offices and is equipped with many of the same features as the pedestal. However, because of its compact size, the safe-box is equipped with a mounting mechanism to be securely mounted to a wall or tabletop, but the primary security is provided by the unit's electronic sensor and IoT capabilities. The safe-box locker system may include power and data ports.

The safe-box 2300 is configured to be used in either of 2 orientations: horizontally on a table or rotated 90 degrees for setting vertically on a table, bookshelf, or even the floor. Alternatively, the safe-box locker system can be mounted to a wall in the vertical position. In this embodiment, a user-friendly input/output module and door access function is included to be useful and convenient in both horizontal and vertical orientations.

FIG. 23 shows the primary mechanical components of a secured personal electronic locker form-factor referred to as a safe-box. In this embodiment, and as shown in FIG. 23, a mounting plate and orientation positioned to mount on a vertical wall. In some embodiments, such as shown in FIG. 23, a safe-box form factor includes a single entryway to access the internal vault, which could be, for example, a hinged door that swings open, a door that slides to open or even a drawer that can be pulled to the open position. The entryway can be located on any side of the safe-box, so long as it is easy to operate and access whether in a horizontal position or rotated 90 degrees to a vertical position.

The outer appearance of the safe-box itself may take on any geometrical or ornamental form; it need not be a rectangular prism as shown in the example embodiment of FIG. 23. Functionally, a safe-box form factor resists attack first by its construction (for example, constructed of cold-rolled or stainless steel) and a detailed design that eliminates offset or mismatched surfaces where a tool could be inserted to gain a mechanical advantage for prying. In some embodiments, a steel vault is enclosed within a plastic overlay that further resists physical attack by minimizing attack options.

The safe-box embodiment of a personal electronic locker is configured to be physically secured to a desktop, wall, floor or other physical structure to prevent it from being freely carried away. As shown in FIG. 23, this aspect can be accomplished using a docking station or a locking cable. The docking station can be attached using fasteners to a surface such as a desktop or similar item of furniture or a vertical wall. The safe-box will include a detail on the bottom that conforms to a detail on the docking station such that it will be guided to the correct position to “snap-fit” into place. Once the connection is made, the safe-box cannot be removed from the docking station until the vault door is opened and the release means is actuated by the user.

If the docking station is not an option for securing the safe-box, a locking cable can also be utilized. In some embodiments, the safe-box vault that will accept the cable with a means to firmly secure the cable at each end within the vault, eliminating an attack point outside of the vault and saving the complexity and cost of an external lock.

FIG. 24 shows example electronic components for one embodiment of a safe-box personal electronic locker. Both a pedestal locker embodiment and safe-box embodiments may display selected status information locally to the authorized user when they are actively using the system. Otherwise, the units will not provide security-related status information that could be useful to a person who may use the information to attack the system.

Some embodiments of electronic locker systems, such as a mobile cart (e.g., FIG. 2), a pedestal locker (e.g., FIG. 22, and a safe-box (e.g., FIG. 24) are further configured to operate locally (standalone) when not connected to a remote server; such embodiments save locker transaction records that may occur when the unit is off-line. Once back on-line, such personal electronic locker systems (e.g., pedestal locker, safe-box, mobile cart) are able to provide an update to the remote server from the local record of the set of operating rules and pending transactions stored in the persistent locker data storage for the one or more secured locker compartments.

The user can authenticate to the pedestal locker or safe-box embodiments, or other electronic locker systems incorporated into a secured access transfer system, by scanning an RFID smart credential, by an integrated keypad, by a biometric fingerprint scan, by a bar code or by NFC using a smart phone.

As mentioned above, the personal electronic locker units can be powered by power-over-Ethernet or by a 110V AC to DC converter and includes a rechargeable battery that can provide power for a limited period of time when not connected to a power source. Embodiments of the pedestal locker and the safe-box shown will securely remember the authorized user(s) personal credential which can be used to open the unit even if it is not connected to the network so long as there is a sufficient charge in the battery.

In some embodiments, the pedestal locker and the safe-box may be equipped with a small touch screen display to serve as a user interface. The display may be configured to show, for example, system status, results of user operations and alerts as needed. It may also be configured to serve as a keypad for input of a user's personal PIN code, and/or display icons for other user actions used to configure and operate the personal electronic locker system.

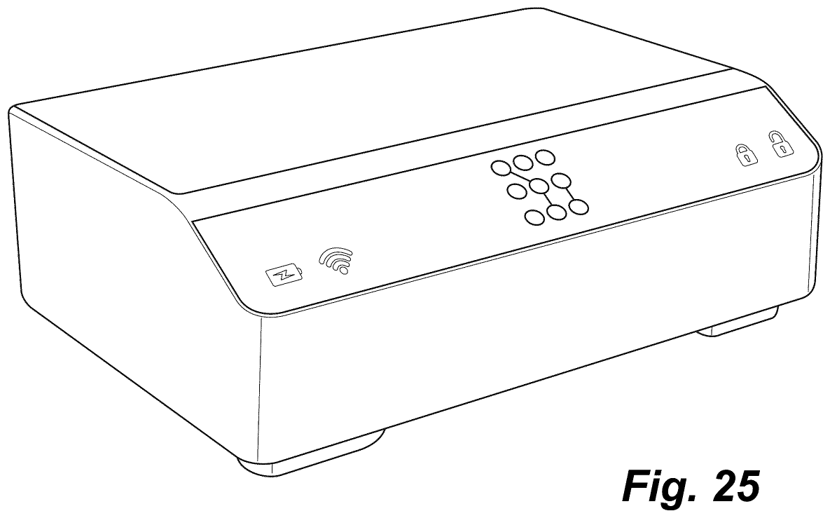

FIG. 25 shows various elements of an alternative personal electronic locker form factor in the form of a desk or table mounted safe-box including the same components as the wall-mounted safe-box except using an alternative secured docking station.

As previously mentioned, one embodiment of a safe-box form factor includes an accommodation to be attached to a mounting dock that is securely attached to a wall, a desk or other physical structure by one or more fasteners such as screws or bolts or even a structural adhesive material in liquid or even tape form. The fasteners are placed such that they are inaccessible when the safe-box is physically attached and locked to the mounting dock. In some embodiments, construction of the mounting dock may be a steel plate, an injection molded plastic with a steel reinforcing plate or a die-cast metal that is finished with a paint or powder coated process.

Various docking systems (docking stations, cables, or other physical locking systems) which may be used to securely attach an electronic locker system to a fixed feature of a physical workspace (such as a wall, desk, or other stationary workspace object) are known in the art and may be used in conjunction with the safe-box embodiment.

In some embodiments, the safe-box is designed to dock by a one-way snap-lock motion such as push, slide or rotate to latch in place. Once the safe-box unit is docked, it cannot be removed until the unit is accessed and the normally locked door is opened, which will allow the user to manually release the safe-box from its docked position. The release motion is a push, slide, lift or rotate operation that is obvious to the user. In some embodiments, it may be necessary to remove the contents of the safe-box before having clear access to release the unit.

In some embodiments, a power cable to the safe-box is configured so that it may be disconnected from the safe-box; this feature enables easy disconnection of the personal electronic locker power supply, so that it can be unplugged and taken with the safe-box should it be moved, as in a portable application. In such embodiments, the safe-box unit includes a mechanical lock override in case the door cannot be accessed by the normal means because of a power failure, the loss of the ID credential, or possibly during the transfer from one user to another. Electronic Locker System Control Panel/User Interface

As mentioned earlier, embodiments of both a pedestal locker and safe-box form factors of a personal electronic locker system are configured to display specific status information locally to an authorized user when in active use; these personal electronic locker systems are also configured to otherwise conceal security-related status information to any non-authorized individual. Embodiments of both form factors can operate locally (standalone) if not connected to a server of the present secured asset transfer system, and each are configured to include features that enable the personal electronic locker to store and later provide locker usage data updates to the server when connectivity is restored.

Embodiments of the personal electronic lockers are configured to include both POE and 15 Volt DC power connectors. The ports may include breakaway connectors to prevent damage whenever a unit is moved and the user forgets to disconnect the power or Ethernet connector. Embodiments are equipped with a rechargeable battery for powering operation for a specified number of door openings over a specified period when not connected to an external power source. To maximize battery life, one embodiment may have the capability to enter into a low-power “sleep” mode when not in active use.

In some embodiments, there are two use profiles or operations: (1) opening the unit and (2) closing the unit. For example, when opening a pedestal locker or safe-box that is locked, in some embodiments, the user must present an access credential. The access credential may be, for example, an RFID card, a smart phone with a QR code or NFC smart reader, a numeric Pin-code or a biometric. In some embodiments, a 2-Factor process may be used, to require two of the three factors commonly called “something you have, something you know or something you are.” In one embodiment, once the access credential has been presented, the personal electronic locker will check information stored in its persistent locker data storage to verify the person has access rights. If they do not, the lock will not be opened by the locker control unit, an alert will be stored in the persistent locker data storage and uploaded to the server application. A local alarm could be activated as well. The persistent locker data storage is in the main control board on the unit; it could be in the main processor or a separate memory chip.

Authorizing user access to any form factor may be accomplished with the above-described process, although different form factors may include variations on the physical user interface used for presenting the access credential. If the user is authorized access, in some embodiments, an indicator on the locker compartment of the electronic locker system will illuminate (as shown, for example in FIG. 21), and a locker compartment lock module is released, allowing the secured locker compartment to be opened. In the case of the pedestal embodiment described above, for example, the front drawer can be pulled forward, and in the case of the safe-box embodiments described above, the door can be moved from a closed position to an open position. If these access operations are not completed within a “time out” period of (for example) a few seconds, in some embodiments the lock module will relock; this aspect prevents the locker compartment from accidentally being left in the unlocked condition even if locker compartment appears to be locked. During this time, the electronic locker system will perform certain specified self-checks, display the results locally and report an access transaction to the system administration application of the secured asset transfer system.

In some embodiments, the pedestal, safe-box or other personal electronic locker form factor is closed simply by pushing in a drawer or closing a door, which will move the lock module into a locked state and after a delay of specified duration from 0 seconds to 20 seconds the unit will remain locked until the next access transaction. During the delay time, the electronic locker system is configured to perform and display specified self-checks locally and to report a locking transaction to the system administration application at the server. Self-checks may include, for example, verifying contents in a payload area (e.g., the secured locker compartment or a virtual-locker locker compartment described above), checking battery status and displaying results locally on an LED indicator panel, as further described below (and shown, e.g., in FIGS. 20 and 21). The delay also provides time for the user to observe the status and possibly re-open the unit before the locking function is completed.

In some embodiments, when an existing corporate RFID card is used for access authorization, a card reader can be configured to read the existing card provided it is based on an open standard such as FIPS-201. Alternatively, an open or propriety RFID card can be provided that will interface with the card reader. In some embodiments, the card reader format may be set to either standard Wiegand or OSDP format which can include customized functionality within the standard. Other formats may be used.

In some embodiments, access privileges are maintained by the system administration application executing on a server which can be integrated with an enterprise's existing access control system via an API or SDK. The locker manager application may be configured to reside on the locker system, on a network server, and/or in the cloud on a virtual server, and may be configured to download authorized access information, for example, a unique identifier, email address and access privileges with valid dates for each authorized user to have access to a locker compartment under local control; such authorized access information is maintained in the persistent locker data storage of the electronic locker system's local compartment control unit for quick response to a request for access. Such configuration enables access even if the electronic locker system (such as a pedestal locker or safe-box) is off-line when access is requested.

Referring back to FIG. 21, one example of a set of electronic indicators that may be included in some embodiments of the electronic locker system. In some embodiments, a personal electronic locker (e.g., pedestal locker, safe-box) includes illuminated indicators on its locker control panel, as shown for example in FIG. 21. In some embodiments, the locker control panel further comprises one or more control buttons integrated with the locker control panel of the personal electronic lockers described above (e.g. a pedestal locker or a safe-box form factors described above). A set of control buttons may include, for example, push buttons, slide switches and/or toggle switches, and located on a front control panel or in the rear deck area (see e.g. FIGS. 18 and 19). In some embodiments, a push button switch is used with the following example functionality:
With power OFF, press and hold for >2 seconds or flip switch to power the unit ON
With power ON, press and hold for >2 seconds or flip switch to power the unit OFF
With power ON, if a push button switch is present, it can be pressed briefly and then released to display specified information or perform certain functionality such as reset connectivity enter low-power sleep mode.

Some embodiments may include a local audio indicator (e.g., a piezo speaker) that can support an optional alarm indications, such as low-battery, lock not locked, tamper alert, etc. The alarm indications may be implemented as momentary, local user alerts.

In some embodiments, a multiple-axis linear accelerometer is included to detect vibration and motion associated with tampering. In such embodiments, a tamper mode can be set from the locker manager application or locally by either by one of the switches or at the keypad. A slide switch located on the interior side of the control module is utilized to activate the tamper alarm if it is being controlled locally. In the ON position, the alarm would be activated whenever a personal electronic locker system was locked and deactivated whenever the personal electronic locker system was unlocked. In some embodiments, reporting of a tamper alert is set to be active in the locked condition to prevent false alarms during use when an electronically secured locker compartment is unlocked/accessed by an authorized user. Tamper alarms are set to be active only during specific days and time periods. In some embodiments, such as a pedestal locker and a safe-box, the electronic locker system will report tamper alerts to the system administration application. If a tamper alert is sent to the system administration application, the system administration application is configured to send an email alert to one or more designated security people and will activate a flag in the application. The flag will remain as an alert until removed by a system manager who has determined by communication with the designated security person or unit owner to determine the issue is resolved securely.

In order to conserve power, a pedestal locker or safe-box will enter a low-power “sleep” mode after a short period of time if there has been no active use following an opening or closing of the unit.

As shown in FIG. 21, a personal electronic locker may have as many as five (5) indicators on the locker control panel which are illuminated to show various locker status conditions. These LED's display information locally to an authorized user when the personal electronic locker is being used (opened or closed). Security-related information, such as locked, unlocked or “item present” is otherwise not displayed to prevent the casual passerby from observing security-related status information (e.g., Unlocked with Item present).

In the secured asset transfer system, LED indicators (with the exception of the Power and Network Status LED's) are only activated when the pedestal locker or safe-box are actively being used (opened or closed).

In some embodiments, and for example, the control panel LED's provide the following information (specific colors and functioning of flashing/solid functions may vary):

Power Status Indicator (Battery Icon):
Solid Green indicates the unit is being powered from the DC power supply.
Solid blue indicates Unit is powered from PoE
Flashing Red indicates Unit is being powered from the battery (no line or POE power)
LED dark indicates the unit is powered OFF
Note this Icon is operational so long as power is available

Network Connectivity Indicator LED (Blue):
Reports Status of Network Connectivity):
Solid Blue indicates network is connected; if the Blue LED is Off, the pedestal is not connected.
NOTE: this Icon is operational so long as power is available

Lock Closed LED (red):
When the card reader detects a card, the Red “locked” LED will turn on and start flashing; if access is denied, the LED will turn solid Red for 5 seconds. If access is granted, the Red LED will turn off and the Green “unlocked” LED will turn ON for 8 seconds, during which time the User can pull the Drawer open.
The LED will also turn red for approximately 5 seconds after drawer is closed and locked.
The LED is off except during the above operations

Lock Opened LED (green):
When being used, reports that unit is Unlocked (LED is normally OFF)
If a card is presented and once access is granted (approximately 2-3 seconds), the “unlocked” LED will turn green. The LED will stay ON for 8 seconds indicating unlocked condition. If drawer is not pulled open within 8 seconds, then the lock will automatically relock, the green LED will turn off and red LED turns on for 8 seconds, indicating Drawer is relocked.
The LED is off except during the above operations

Item Detected Spyglass LED (White):
Reports the presence of an item in personal electronic locker
The LED is normally OFF when the unit is not being actively unlocked or locked. When drawer is moved to the closed position, the Red Closed LED is will turn ON for 8 seconds and the sensors will check for the status of an item present in the electronically secured locker compartment
If no item is detected when the drawer is closed, the LED will flash White for approximately 8 seconds to indicate that no item has been detected. If an item is detected, the LED will turn solid White. The White LED will continue to flash or be solid White until the Red LED turns OFF (8 seconds).

In the above example, and in some embodiments, LED Indicators pertaining to security conditions will only be active during active operation (locking and unlocking) of the unit as outlined above. In some embodiments, the LED status indicators for locked, unlocked and item detected are not active except when the unit is being opened or closed. This operation thus serves to provide immediate feedback to the user when needed, but it does not provide security status indication to the casual passerby.

As discussed above, personal electronic locker form factors are intended for modern open offices and offices where the workers may follow a hybrid schedule. The personal electronic locker form factors are configured to facilitate worker migration from workplace location to workplace location, permitting simplified and secured relocation of personal physical assets housed within, for example, a pedestal. The pedestal is one embodiment of a personal electronic locker form factor that is mobile and intended for use by a worker as they move through the workspace, work facility, or campus, or to a remote location such as a home office under a hybrid work schedule. During such times, and/or while mobile, the pedestal locker or other personal electronic locker system may become disconnected from Internet connectivity and a power source; at other times, the user may not be able to locate an available power socket. Thus, in some embodiments, the personal electronic locker includes a low power sleep mode for the main processor board, to save on battery power. In such embodiments, when in sleep mode, the personal electronic locker system is configured to utilize a proximity sensor to initiate a “wake-up.” The sensor may be configured to activate the main processor board when an object such as a hand or access card is held within a few inches of the sensor for at least one-second. The personal electronic locker will power-on, return to the “active” mode and attempt to authenticate the access credential whether it be a user ID card or possibly a barcode or a biometric. If the access credential such as am ID card is not detected, the personal electronic locker system will return to the sleep mode.

The above-described embodiment designed for a sensor wake up function can also be used for a biometric fingerprint scanner integral with the personal electronic locker. When in sleep mode, one or more keypad buttons will be active, and in some embodiments, pressing any button will make a hard contact and wake up the main processor board. In some embodiments, an initial key press will be entered as the first digit of an access code, and the remaining numbers of the access code may then be entered followed by the enter key. In some embodiments, the length of the access code (for example, three to eight digits) is set by an administrator via the system administration application executing on the server.

The technology is implemented using hardware, software, or a combination of both hardware and software. The software used is stored on one or more of the processors' readable storage devices described above to program one or more of the processors to perform the functions. Readable storage devices can include computer readable media such as volatile and non-volatile media, removable and non-removable media. By way of example, and not limitation, computer readable media may comprise computer readable storage media and communication media. Computer readable storage media may be implemented in any method or technology for storage of information such as computer readable instructions, data structures, program modules or other data. Examples of computer readable storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. A computer readable medium or media does (do) not include propagated, modulated or transitory signals.

Communication media typically embodies computer readable instructions, data structures, program modules or other data in a propagated, modulated or transitory data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as RF and other wireless media. Combinations of any of the above are also included within the scope of computer readable media.

In alternative embodiments, some or all of the software can be replaced by dedicated hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), special purpose computers, etc. In one embodiment, software (stored on a storage device) implementing one or more embodiments is used to program one or more processors. The one or more processors can be in communication with one or more computer readable media/storage devices, peripherals and/or communication interfaces.

It is understood that this disclosure may be embodied in many different forms and should not be construed as being limited to the specific embodiments mentioned. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the disclosure's subject matter may be practiced without such specific details.

With reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The description of this disclosure has been presented for purposes of illustration and description but is not intended to be exhaustive or limited to the disclosure in the form disclosed. Many modifications and variations will be apparent to those of ordinary skill in the art without departing from the scope and spirit of the disclosure.

For purposes of this document, each process associated with the disclosed technology may be performed continuously and by one or more computing devices. Each step in a process may be performed by the same or different computing devices as those used in other steps, and each step need not necessarily be performed by a single computing device.

While various embodiments of the invention have been described, it will be apparent to those of ordinary skill in the art that many more embodiments and implementations are possible that are within the scope of this invention.

What is claimed is:

1. A secured asset transfer system comprising:
an electronic locker system including a secured network connectivity to at least one electronically securable locker compartment, a locker processor executing a locker management application operable to monitor and control access to the at least one electronically securable locker compartment and determine a set of locker usage data, and a persistent locker data storage storing the locker management application;
a server system including a secured network having connectivity with the at least one electronically securable locker compartment, and having a server processor, a server memory electronically coupled to the server processor, and at least one server database stored in the server memory, where the server processor executes a system administration application stored in the server memory and operable to identify and record a form factor associated with the electronic locker system and selected from a plurality of locker form factors, that monitors usage of and enabling access to the at least one electronically securable locker compartments; and
a secured communication link between the electronic locker system and the server system, where the locker management application is further operable to transmit the set of locker usage data from electronic locker system to the server system over the secured communication link, and where the system administration application is further operable to process the set of locker usage data to dynamically update locker profile information and facilitate reconfiguration of the electronic locker system based upon the locker profile information.
